(19) United States
(12) Patent Application Publication
(10) Pub. No.: US 2016/0068440 A1
(43) Pub. Date: Mar. 10, 2016

(54) POROUS MASSES OR MOULDED BODIES CONSISTING OF INORGANIC POLYMERS AND PRODUCTION THEREOF

(71) Applicants: Bernd Spangenberg, Offenburg (DE); Wolfgang Hemmer, Speyer (DE); Sidon Futterknecht, Berlin (DE)

(72) Inventors: Bernd Spangenberg, Offenburg (DE); Wolfgang Hemmer, Speyer (DE); Sidon Futterknecht, Berlin (DE)

(73) Assignee: SEAL-TEC GMBH, Kassel (DE)

(21) Appl. No.: 14/769,848

(22) PCT Filed: Feb. 24, 2014
(86) PCT No.: PCT/DE2014/000076

§ 371 Date: Oct. 15, 2015

(30) Foreign Application Priority Data
Feb. 22, 2013 (DE) 10 2013 002 972.4
Oct. 18, 2013 (DE) 10 2013 017 307.8
Oct. 18, 2013 (DE) 10 2013 017 308.6
Nov. 4, 2013 (DE) 10 2013 018 492.4

(51) Int. Cl. C04B 28/00; C04B 38/02; C04B 38/00; B22C 1/18

(52) U.S. Cl. CPC C04B 28/008; B22C 1/188; C04B 38/02; C04B 38/0074; C04B 38/0067; C04B 2111/40

(57) ABSTRACT

Disclosed is a method for producing a porous mass or a porous moulded body consisting of an inorganic polymer, according to which water glass is tempered using specific amounts of a carbonate, thus allowing the addition of various other materials. Disclosed are also porous masses and moulded bodies which can be obtained by means of the method and the use of said masses and moulded bodies.

### TECHNICAL FIELD

The present invention relates to a method for producing porous masses and shaped bodies of inorganic polymers and to masses and shaped bodies obtained by this method and the use thereof e.g. in the building sector and for foundry auxiliary bodies.

### BACKGROUND

Inorganic polymers are known. Thus a reaction between water glass, i.e. sodium silicate, and metakaolin (Al₂Si₂O₇) is often called geopolymerization in the literature. Geopolymerization is based on the formation of polymeric structures between oxygen, silicon and aluminum. Water glass is reacted with metakaolin with sodium or potassium hydroxide solution being admixed as an activator; the optimum pH of this reaction is in the range of from pH 13 to 14. According to J. Davidovits in “GEOPOLYMERS Inorganic polymeric new materials”, Journal of Thermal Analysis, vol. 37 (1991), p. 1633 to 1656 this reaction is an OH-catalyzed polycondensation of SiOH and AlOH groups to give a mixed silyl ether (SiOAl) by dehydration. A characterizing feature of this reaction is its long duration of several hours to days. To accelerate it, it is usually carried out at elevated temperatures (80-160° C.). The three-dimensional network formed comprises covalent —Si—O—Si— and —O—Si—O—Al—O— bonds in the form of Si and Al tetrahedra, which are linked to one another via in each case four oxygen atoms. The bond lengths between silicon and oxygen (Si—O: 1.63 Å) and aluminum-oxygen (Al—O: 1.73 Å) have almost the same length. Virtually no —O—Al—O—Al—O— bonds are formed (Löwenstein's rule).

Each aluminum tetrahedron (AlO₄⁻M⁺) is thus usually surrounded by four SiO₄ tetrahedra.

The production of foams with geopolymers is regarded as possible, but very difficult. This makes it difficult to use the known geopolymers for insulating materials.

However, insulating materials are gaining increasing importance because of the shortage of petroleum quantities available worldwide and the need to reduce CO₂ emissions. A large proportion of petroleum production is used for heating. Enormous amounts of petroleum can therefore be saved by insulating houses. However, insulation is currently usually achieved with organic materials, such as foamed polystyrene, which is combustible and impermeable to water. If ventilation of the house is poor this rapidly leads to mold growth and in the event of fire melting and dripping polystyrene impedes evacuation of the inhabitants. Furthermore, polystyrene itself is produced from petroleum.

There are a number of documents which are concerned with foaming of inorganic substances and other uses of inorganic substances.

Thus DE-OS 23 23 488 discloses a method for producing foamed or compact substances with which the solidification of inorganic substances is carried out in the presence of boron phosphate and polyhydroxylated organic compounds. Mixtures of alkali silicates and urea-formaldehydes are said to be employed as aqueous solutions. The reaction product of boric acid and phosphoric acid (boron phosphate) is said to work well in inorganic-organic systems and a solidification of the silicic acid in the water glass is said to take place in the desired manner by slow hydrolysis.

EP 1 241 131 A1 discloses the use of polymeric aluminum phosphate as an agent for regulating the setting, in particular curing, of plasters, wherein the polymeric aluminum phosphate is said to have a particular P:Al molar ratio, a particular ratio of the different B and A forms is said to be established by tempering, the amorphous material content is between 15% to 70%, the particle size distribution D₅₀ is 0.1 μm to 100 μm, the water-soluble content is said to be greater than 2% and the content of Al₄ (P₄O₁₂)₃ is said to be greater than 1%. It is mentioned that polymeric aluminum phosphate is said to be used in the form of an anhydrous suspension, and the water-soluble lower alcohols, copolymers of ethylene oxide/propylene oxide, the block polymers of ethylene oxide, propylene oxide, mono- and dimethylene glycol, alkyl ethers, in particular triethylene glycol alkyl ethers and dipropylene glycol alkyl ethers, are said to be employed as liquids for this suspending.

DE 28 13 473 C3 discloses a method for producing an expanded material based on alkali metal silicate from a mixture of at least one alkali metal silicate and at least one pore-forming agent in the form of aluminum or silicon as well as active and optionally inactive substances, wherein the expansion is said to be carried out in the presence of a methyl ester and/or propylene carbonate. The methyl ester is said to be formed in situ during the expansion.

DE 36 17 129 A1 discloses solid foams based on silicate, wherein silicate solutions are said to be foamable to in situ foams employing gases without external supplying of heat, by chemical reaction of an added gas generating system. Gases which are inert or reactive towards aqueous silicate solutions, in particular oxygen, carbon dioxide, nitrogen, ammonia, hydrogen or dinitrogen monoxide, are proposed as foaming gases. Oxygen for foam formation is said to be generated with hydrogen peroxide, which is unstable in the alkaline media prevailing there and is said to be decomposed for generation of oxygen by catalysts, for example chromium(VI) compounds, manganese dioxide or permanganate, salts of transition metals, activated carbon, pumice powder or other powder substances having a high specific surface area. In addition, generation of CO₂ for example by isocyanates, generation of nitrogen from ammonium compounds etc. is discussed. Hydrolyzable organic esters, sodium fluorosilicate, potassium fluorosilicate, calcium fluorosilicate, potassium fluoroborate, calcium fluoroborate, calcium fluorotitanate, polyvalent metal salts, weak acids, organic borates, alkoxy esters of polyvalent metals, carboxylic acid esters of polyvalent metals, binary organic salts, cements capable of curing silicate, sodium aluminate, aluminum and iron phosphates, zinc borate, metal oxides, alkali metal bicarbonates, alkali metal hydrogen phosphates or mixtures thereof are proposed for curing the silicate foams. Hydraulic materials, such as cements, gypsum, polyisocyanates or water-dispersible matrix-forming synthetic resins are proposed as matrix-forming substances. The possibility of a thermal after-treatment is discussed.

DE 40 40 180 A1 discloses a molding composition or a kit of components comprising several parts for producing a solid foam product, with an inorganic stone-forming component, a water-containing second component which effects the curing reaction of the stone-forming component in the alkaline range, and with a foam-forming component, wherein the addition of a surface-active, amphiphilic substance in an amount sufficient to influence the pore structure or strength is proposed.

DE 32 46 619 discloses an inorganic shaped body made at least partially of foam and based on alkali metal silicate, which is formed from water-containing molding compositions by casting and curing by heating, and indeed from an oxide mixture with contents of amorphous SiO₂ and aluminum oxide, silica, alkali metal silicate solutions, optionally alkali metal hydroxide, optionally in aqueous solution, and optionally fillers and foaming agents. A maturing or waiting time between casting in the mold and possible formation of the shaped body by heating is likewise mentioned. Fillers which are discussed are inorganic substance in ground or divided form, for example powdered stone, basalts, clays, feldspars, mica powder, glass powder, quartz sand, quartz powder, bauxite powder, hydrated alumina, waste products of the alumina, bauxite or corundum industry, ash, slag, fiber materials and further inert water-insoluble mineral and optionally organic minerals. Lightweight fillers, such as pumice powder, vermiculites or perlites, are stated as preferred for foamable molding compositions.

DE-OS 36 17 129 discloses the foaming of aqueous silicate solutions with gases.

DE 197 17 330 A1 discloses the use of inorganic foam materials comprising silicon oxide and/or aluminum oxide, a curing agent from alkali metal water glass and a blowing agent from hydrogen peroxide for producing a housing for installing sanitary equipment constituents which comprise piping lengths assembled into a ready-to-install installation group with shut-off devices, regulating devices and/or monitoring devices.

DE 197 06 492 A1 discloses a building brick for statically loadable masonry as a homogeneous solid brick with an open-cell structure. A very low body bulk density is said to lead to a relatively low thermal conductivity. At the same time the nature of a foam admixed during the production and of the stabilizer used is said to have the effect that a stable matrix forms at the pore boundaries which renders relatively high compressive strengths possible, for which slip is said to be mixed into surfactant foam, and the surfactant foam is said to contain silica as a stabilizer.

EP 0 148 280 B1 discloses water-containing, curable molding compositions of inorganic constituents in flowable or pressable distribution with optionally contained contents of fillers.

DE 10 2005 051 513 A1 discloses low-sodium silicate foam materials for which a dispersion of SiO₂ particles is mixed with a surfactant and a blowing agent at temperatures below 50° C. and the mixture is foamed at a temperature between 60° C. and 100° C. or with release of pressure. A sintering can then be carried out in the range of from 200° C. to 500° C.

DE 10 2008 058 664 A1 discloses a spontaneous foaming and curing mineral foam, wherein oxygen is liberated by catalytic decomposition of hydrogen peroxide for the foaming.

DD 296 676 A5 discloses an inorganic foam body which is formed from an at least partially open-cell mixture, foamed by heating and cured, of alkali metal water glass and a filler from the group of aluminum oxide, silicon dioxide, alumina cement, powdered stone and graphite or mixtures and is said to have a certain bulk density. The mixtures described by way of example must be heated.

DE 100 29 869 A1 discloses a fiber-free, non-combustible foamed insulating and fireproof material based on inorganic materials, which is said to comprise a content of from 5 to 20 wt. % of swellable laminar silicate, 30 to 80 wt. % of silicate rods, 10 to 40 wt. % of colloidal silicon dioxide, aluminum oxide and/or alkali metal silicate, 0.05 to 10 wt. % of aluminum sulfate and 0 to 5 wt. % of a hydrophobizing agent.

DE 101 41 777 A1 discloses an inorganic foam based on an alumosilicate with a molar ratio SiO₂:Al₂O₃ of from 20:1 to 1:1, which has a density of less than 25 g/l. Hydrocarbons, alcohols, ketones and esters are mentioned as blowing agents.

DE 196 16 263 A1 discloses a method for producing aerogels and xerogels. In this method the gel precursor is said to be treated with an aprotic solvent which is soluble in CO₂. Propylene carbonate is stated as the preferred solvent, which is said to be mixed with inorganic gels, the organometallic compounds etc. A solvent, for example propylene carbonate, water and acid, preferably hydrochloric acid, are said to be added to the mixture in order to produce a transparent gel after one to two days.

DE 196 28 553 C1 describes a foam material for fireproofing and/or insulating purposes, which is formed from a solution which comprises Al(H₂PO₄)₃ and water, and a mixture of MgO mica, aluminum hydroxide and MnO₂ as well as from a foam-forming agent with H₂O₂ and water. It is stated that inorganic fillers and, as processing auxiliaries, inter alia polyacrylic acid esters, polyurethanes, polyvinyl alcohol, polyethylene can be used.

The paper “Wasserglas-Ester-Formstoff für Guβstücke aus Guβeisen” by H. Glaβ in Gieβerei-Praxis 1-2/2006, pages 22 to 26 discloses the use of a molding material system with quartz sand, soda water glass as a binder liquid and glycerol ester of acetic acid, which can be present as mono-, di- or triacetate, as a curing agent component. The amount of curing agent is said to be about 1/10 of the amount of binder.

The paper “Mechanism of geopolymerization and factors influencing its development: a review” by D. Khale and R. Chaudary in J. Mater. Sci. (2007) 42:729-746 discloses geopolymers, wherein reactions of geopolycondensation, in particular orthosialate formation and alkali metal polysialate formation and the conversion of ortho(sialate-siloxo) into polysialate-siloxo compounds are discussed. The fact that the pH is the most important factor for the compression strength of products is also discussed. The action of phosphate salts in delaying gel solidification is discussed.

“GEOLOPOLYMERS Inorganic polymeric new materials” by J. Davidovits in Journal of Thermal Analysis, vol. 37 (1991), pages 1633 to 1656 furthermore discloses that certain inorganic substances can undergo polycondensation at temperatures below 100° C.

Reference may furthermore be made to: Andree Barg, Dissertation, Paderborn 2004; Anja Buchwald, Was sind Geopolymere? Betonwerk and Fertigteil-Technik (BFT) 72 (2006), 42-49; Radnai, T., May, P. M., Hefter, G. and Sipos, P. (1998) Structure of aqueous sodium aluminate Solutions: A Solution X-ray diffraction study. Journal of Physical Chemistry A, 102 (40). pp. 7841-7850; James Murray, Davis King, Oil's tipping point has passed, Nature 481 (2012), 433-435; Iwan Sumirat, Y. Ando, S. Shimamura, Theoretical consideration of the effect of porosity on thermal conductivity of porous materials, J. of Porous Materials, 13 (2006), 439-443; J. Davidovits, J. Mater. Educ. 16, (1994), 91-137; H. Rahier, B. van Mele, J. Wastiels, X. Wu: Low-Temperature synthesized aluminosilicates glasses, Part I: Low-temperature reaction stoichiometry and structure of a model compound. J. Material Science, 31 (1996), 71-79; H. Rahier, B. van Mele, J. Wastiels, Low-Temperature synthesized aluminosilicates glasses, Part II: Rheological transformation during low-temperature cure and high temperature properties of a model compound. J. Material Science, 31 (1996), 80-85; H. Rahier, W. Simns, B. van Mele, M. Briesemans, Low-Temperature synthesized aluminosilicates glasses, Part III Influence of the composition of the silicate solution on production, structure and properties, J. Material Science, 32 (1997), 2237-2247; W. D. Nicoll, A. F. Smith, Stability of Dilute Alkaline Solutions of Hydrogen Peroxide, Industrial and Engineering Chemistry, 47 (1955), 2548-2554; E. Ronsch, A. Porzel, Chemische Modifizierung and Untersuchungsmoglichkeiten von Wasserglaslösungen als Bindemittel für Gieβereiformstoffe, Gieβereitechnik 27 (1988), 348-351; K. J. D. MacKenzie, I. W. M. Brown, R. H. Meinhold, Outstanding Problems in the Kaolinite-Mullite Reaction Sequence Investigated by ²⁹Si and ²⁷Al Solid-state Nuclear Magnetic Resonance: Metakaolinite, J. Am. Ceram. Soc. 68, (1985), 293-297; Puyam S. Singh, Mark Trigg, Iko Burgar, Timothy Bastow, Geopolymer formation process at room temperature studied by ²⁹Si and ²⁷Al MAS-NMR, Materials Science and Engineering A 396 (2005), 392-402; Zhongqi He, C. Wayne Honeycutt, Baoshan Xing, Richard W. McDowel, Perry J. Pellechia, Tiequan Zhang, Solid-state fourier transform infrared and ³¹P nuclear magnetic resonance spectral features of phosphate compounds, Soil Science 172 (2007), 501-515; S.-P. Szua, L. C. Klein, M. Greenblatt, Effect of precursors on the structure of phosphosilicate gels: ²⁹Si and ³¹P MAS-NMR study, J. Non-Cryst. Solids 143 (1992), 21-30; H. Maekawa, T. Maekawa, K. Kawamura and T. Yokokawa, The structural groups of alkali silicate glasses determined from ²⁹Si MAS-NMR, J. Non-Cryst. Solids 127 (1991), 53-64.

EP 2 433 919 A1 describes a curing agent composition for controlling the setting behavior of an alkali metal silicate binder. EP 0 495 336 B1, EP 0 324 968 A1, WO 89/02878 A1, JP 57063370 A, ZA 8802627 A, EP 0 455 582 A, DE 32 46 602 A1, U.S. Pat. No. 4,642,137 A, U.S. Pat. No. 4,983,218 A, GB 1 283 301 A, GB 1 429 803 A, WO 95/15229 A, DE 2 856 267 A1, EP 0 641 748 A1, DE 697 34 315 T2, GB 1 429 804 A and EP 0 495 336 B1 may also be mentioned.

Nevertheless, improvements in the product properties and production thereof are still desirable.

It is worth aiming to be able to provide mineral alternatives to the non-mineral and mineral building and insulating materials currently used. It is furthermore desirable to open up new possible uses.

It is desirable for the starting substances or components which are used for producing an inorganic polymer to be adequately stable in storage, for recyclability to be ensured and for only minor safety regulations to none at all to have to be observed during processing. The polymer should preferably be easy to produce without heating. It is furthermore desirable to achieve a sufficiently rapid curing, in particular a curing which is so rapid that on the one hand a good processability is ensured, i.e. the reacting mass can still be applied, used in construction, cast, spun etc. as desired, but on the other hand also the period up to curing does not last too long. It is furthermore desirable, when the inorganic polymer is used as a substance to be applied, to be able to ensure a good adhesion to the substrate on a particular, if possible even different substrates, e.g. concrete walls, existing plaster layers, iron galvanized surfaces etc. The porosity of the polymer should be adjustable in a simple manner during the production in order to render a broad range of uses possible. The finished polymer should nailable, grindable, savable etc. without cracking. The material should furthermore be resistant to fungi and acid, non-combustible and/or fire-resistant and/or resistant to heat and/or UV.

The object of the present invention is to provide a method for producing a porous mass or a porous shaped body which fulfills at least some of the properties described above. A further object is to provide a porous mass or a porous shaped body which has at least some of the properties described above.

The object is achieved by the method defined in the claims and the products defined in the claims.

### DESCRIPTION OF THE FIGURES

FIG. 1 shows the light absorption based on the reference case of transmitted light in air

FIG. 2 shows Al MAS-NMR spectra of the metasilicate employed (metakaolins) and of a polymer obtained

FIG. 3 shows an Si MAS-NMR spectrum of a polymer obtained

FIG. 4 shows a ³¹P NMR spectrum of Na₅P₃O₁₀ and of a polymer obtained

FIG. 5 shows the dependency of the compressive stability in MPa (▴) and the thermal conductivity in W/mK (♦) on the porosity

FIG. 6 shows the dependency of the viscosity on various additives

FIG. 7 shows an optical microscope photograph of a porous product obtained

FIG. 8 shows a surface photograph of a test specimen

FIG. 9 shows an optical microscope photograph of a test specimen at a magnification of ×500

FIG. 10 shows an optical microscope photograph of a test specimen at a magnification of ×200.

### DETAILED DESCRIPTION OF THE INVENTION

In the method according to the invention a first composition (composition a) in the following) is brought into contact with a second composition (composition b) in the following) for a polycondensation.

Composition a) is an aqueous composition which comprises sodium and/or potassium water glass dissolved in water.

Water glasses are usually produced from sand and Na or K carbonate. They comprise silicates which are readily soluble in water, the negative charge of which are compensated by monovalent counter-cations (M⁺).

It is possible to employ one sodium water glass (sometimes also called soda water glass) or a mixture of various sodium water glasses. It is moreover possible to employ one potassium water glass (sometimes also called potash water glass) or a mixture of various potassium water glasses. The use of one or more potassium water glasses is preferred to the use of one or more sodium water glasses since a higher compressive stability can often be achieved.

According to one embodiment a mixture of sodium and potassium water glass, such as e.g. a 90:10 to 10:90 mixture, e.g. a 50:50 (based on the total weight of dissolved water glass) mixture or a 90:10 mixture, is used.

Water glasses are characterized by their s value which indicates the mass ratio SiO₂/M₂O (M=alkali metal); the lower the s value the more alkali metals are present. Water glasses having various s values are commercially obtainable.

For instance water glasses having s values in the range of from 0.7 to 8 are known. Water glasses having an s value of 1.3-5 are preferably used for the present invention.

Possible potash water glasses for the invention are e.g. those having an s value of 1.3-4.5, preferably 1.3-3.5 or 1.3-2.5.

Possible soda water glasses for the invention are e.g. those having an s value of 2-5, preferably 3-4.5.

According to one embodiment a mixture of water glasses in which the content of water glass having an s value of from 1.3 to 5 is at least 90%, based on the total amount of water glass dissolved in composition a), is used.

By using a mixture of potash and soda water glass it has been possible, surprisingly, to improve the resistance to cracking and the shrinkage properties of the product. The use of potash water glass usually has a favorable effect on the compressive stability of the product.

Aqueous solutions of water glasses are viscous. Soda water glasses as a rule lead to a higher viscosity than potash water glasses with the same SiO₂ content (s value).

The viscosity of composition a) can be varied by the nature and amount of the water glass used or the water glasses used and optionally the use of further components, e.g. such that a value of 10-1,000 mPa·s (25° C.) is achieved without or before the addition of a surfactant. If composition a) comprises no methyl siliconate e.g. a viscosity value (measured without surfactant at 25° C.) of 20-350 mPa·s may be favorable. The viscosity is measured in this context with a rotary viscometer having a barrel-shaped spindle at 25° C. (Brookfield viscometer DV-II+Pro with standard spindle RV 06). Without methyl siliconate (and without or before the addition of surfactants) the viscosity according to a further embodiment is 50-250 mPa·s or 8-50 mPa·s.

For the preparation of composition a) e.g. commercial water glass solutions having a solid content of 30-48 wt. % can be used as the starting substance.

Water glasses can also be characterized via their structural properties with respect to the silicon groups present.

The s value of a water glass determines the chemical constitution in which the silicate is present. At an s value of s=1 the silicate has on average a negative charge. Theoretically, the s value can fall to 0.25. The formula of such a potash silicate would be K₄SiO₄, i.e. a four-fold negatively charged silicon/oxygen tetrahedron. This functional group is called Q₀ in the following. When an Si—O—Si bond is formed from such a Q₀ group by condensation, a Q₁ group is obtained. Exactly one O—Si group hangs on the central silicon atom. The suffix therefore designates the number of bridge-forming oxygen atoms which bond to this silicon atom. Accordingly, a central silicate group with two bonds to silicon atoms is called a Q₂, with three bonds a Q₃ and with four bonds a Q₄ group. The Q₄ group no longer carries a negative charge and is neutral.

The various silicon groups can therefore be characterized as follows:

Q₀: monosilicate
Q₁: end group
Q₂: central group
Q₃: branching group
Q₄: crosslinking group

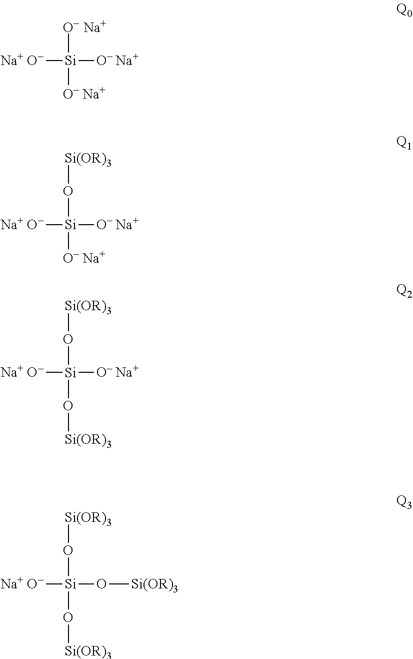

The Si—OR group here is a spacer for a further branching of the Si—O—Si skeleton. The Q₄ group, which is not shown, no longer has a negative charge but consists only of Si(OR)₄ groups, which can no longer react in the sense of a polycondensation reaction.

²⁹Si MAS-NMR spectra can be used to determine the percentage contents of Q₀ to Q₄ in a given water glass.

In the context of the present invention and all the embodiments described here, water glasses having the following characterization are preferred:

Preferred range for Q₁: 2-6%

Preferred range for Q₂: 10-25%

Preferred range for Q₃: 15-25%

Preferred range for Q₄: 45-70%,

wherein the area of that peak assigned to a particular silicon group Q(i) is related to the sum of the area of all the Si NMR signals (=100%).

For the present invention it has moreover emerged as essential that the pH of composition a) at 25° C. is at least 12 (measured with a pH meter); preferably, the pH is in the range of from 12 to 13.5.

By using the carbonate curing agent (I) the pH is lowered suddenly in the polycondensation. So that the pH does not fall noticeably below 10 during the reaction, a minimum pH of 12 is necessary for composition a). The pH will conventionally fall by about 1-1.5 units during the reaction.

The inventors have found, surprisingly, that no foam forms, i.e. no porous product is obtained, if the pH falls below 10.

With respect to high strength, uniform pore distribution and pores being as small as possible, the pH of composition a) is preferably not substantially above 13.5.

Due to the alkaline pH composition a) is resistant to fungal colonization and relative stable to acids, which results in a good storage stability.

Composition b) comprises, in addition to water, at least one water-soluble or water-miscible (preferably water-soluble) curing agent, wherein the curing agent is selected from carbonates of the general formula (I)

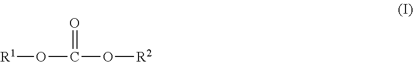

wherein R¹ and R² independently of each other are selected from C₁₋₆ alkyl (preferably C₁₋₄ alkyl, particularly preferably C₁₋₂ alkyl) or R¹ and R² together with the group

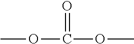

form a 5-membered ring which is optionally mono- or polysubstituted by substituents selected from C₁₋₂ alkyl and C₁₋₂ alkyl substituted by one or more OH. Curing agents having a 5-membered ring are preferred to the open-chain carbonates.

The C₁₋₆ (preferably C₁₋₄, particularly preferably C₁₋₂) alkyl radicals can independently be optionally substituted by one or more OH groups, which can improve the water-solubility of the curing agent.

Suitable examples of curing agents are dimethyl carbonate, propylene carbonate, butylene carbonate (e.g. 1,2-butylene carbonate), glycerol carbonate and ethylene carbonate.

The first three compounds mentioned are low-viscous, water-like liquids which are easy to meter. Ethylene carbonate is a glass-like, readily water-soluble solid. Propylene carbonate and glycerol carbonate are particularly preferred; since the latter is relatively expensive, propylene carbonate is preferred from the economic point of view.

The compounds mentioned display different hydrolysis properties: Ethylene, butylene, glycerol and propylene carbonate are five-membered ring systems and are hydrolyzed instantaneously, that is to say in a few seconds, at a pH of approx. 12, while the hydrolysis of dimethyl carbonate with some minutes, typically up to about half an hour, takes substantially longer. This influences the reaction time in the method according to the invention.

The amount of curing agent added determines not only the number of crosslinkings in the product, but moreover also the hardness of the product. The pore size and porosity can also be influenced by the choice of curing agent and amount of curing agent.

Since the curing agent influences both the pore size and the product hardness, it may be advantageous to use mixtures of various curing agents, especially if large pores (size of from 2 to 8 mm diameter) with a high hardness are desired. For example, a mixture of ethylene and propylene carbonate, could be used. Alongside methanol and 1,2-propanediol, only water-soluble alkali metal carbonates are formed as additional reaction products.

In the reaction of water glass with the carbonates mentioned, in particular ethylene and propylene carbonate, only small amounts of glycol or 1,2-propanediol (C₃H₇ (OH)₂) and water-soluble sodium carbonate (Na₂CO₃) or potassium carbonate (K₂CO₃) are formed. In this context it is important for the invention that two mol of alkali metal cations are collected per mol of propylene carbonate and at the same time two mol of protons, which start and catalyze the polycondensation, are released.

C₃H₇CO₃+2H₂O+2M⁺→C₃H₇(OH)₂+Na₂CO₃+2H⁺

M⁺=K⁺ or Na⁺

All the reaction products can be dissolved almost completely out of the porous polymer with water. Sodium and potassium carbonate were identified via their IR spectra and 1,2-propanediol by means of the IR and ¹H MAS-NMR spectrum.

Since the pH of the mixture, as mentioned above, should not fall noticeably below pH 10, the amount of curing agents also cannot be increased as desired. At the same time a further limitation of the reaction mixture takes effect:

Addition of curing agent in the form of composition b) always means in fact also a dilution of the reaction mixture. However, a mixture should not be diluted without limitation, because otherwise the foam collapses too rapidly. In the case of an excess of curing agent, however, the product rapidly becomes solid and thereby cannot foam correctly.

As explained above, the amount of curing agent employed and the amount of water in composition b) has a decisive influence on the product. The inventors of the present invention have found that the following conditions must be met in order to obtain porous products of good strength:
(A) The amount of carbonate employed in g (m_{c}) is mₛₜₒ to x·mₛₜₒ
(B) The amount of water in composition b) is chosen such that

$$\frac{{m}_{WG}}{{G}_{a} + {G}_{b}} \times 100 \% \geq 25 \%$$

In conditions (A) and (B):

mₛₜₒ=stoichiometrically required amount of carbonate in g calculated from

mₛₜₒ=(MW_{C}/MW_{M}_{₂}_{O})*(m_{WG}/(1+s)) (1)

MW_{C}=molecular weight of the carbonate used
MW_{M}_{₂}_{O}=molecular weight of M₂O from the dissolved water glass (composition a)), where M=Na or K
m_{WG}=amount of dissolved water glass in g in composition a)
s=weight ratio SiO₂/M₂O of the water glass used in composition a)

If a mixture of 2 or more water glasses is employed, mₛₜₒ=Σmₛₜₒ (i), wherein mₛₜₒ (i) is the amount of carbonate calculated according to equation (1) for each water glass (i) with the particular s(i) value.

x=0.35 if dissolved Na water glass is used in composition a) and
x=0.45 if dissolved K water glass is used in composition a)
and
x=0.35*y_{Na}+0.45*y_{K} if a mixture of dissolved Na water glass and dissolved K water glass is used in composition a), wherein
y_{Na} weight ratio of Na water glass, based on the total amount of dissolved water glass, calculated from:
(amount in g of the dissolved Na water glass)/(total amount in g of dissolved water glass)
Y_{K}=weight ratio of K water glass, based on the total amount of dissolved water glass,
wherein y_{Na}+Y_{K}=1,
if a mixture of carbonates is employed:

MW_{C}=Σ(MW_{C}(i)*m(i))

where MW_{C}(i)=molecular weight of carbonate (i)
m(i)=weight ratio of carbonate (i), based on the total amount of carbonate curing agents used
wherein Σm(i)=1.

An example of a calculation of mₛₜₒ is as follows:

For 18 g of soda water glass having a solid content of 34.5% and s=3.3, mₛₜₒ for propylene carbonate is thus calculated as 2.38 g. For 40 g of soda water glass mₛₜₒ for propylene carbonate increases to 5.28 g.

If the carbonates (I) are used as curing agents, a two-stage course of the reaction is assumed: in the first stage, which proceeds rapidly and is completed after a few minutes, reaction of organic carbonate, and thereafter a gradual drying and optionally a residual curing with CO₂ from the air.

It is to be mentioned that during such a drying process by CO₂ from the air bonds can likewise be formed by dehydration and that the water thereby formed exits from the product. This reaction can take between hours and days, wherein for typical situations the initially higher moisture remains stable for one to three days, depending on the size, form and hardness of the body formed, although water is still released, which indicates that during this time curing by chemical bonding of alkali metal cations in the substance also takes place, while thereafter water is essentially released on the basis of physical drying.

In addition to the above essential components of compositions a) and b), these can also comprise one or more optional constituents with which the reaction and/or the properties of the products can be further influenced.

It has been found that using a substance (or a substance mixture) which is present dissolved in composition b) and generates O₂ gas on decomposition favorably influences the foaming and therefore the pore formation in the product.

Examples of suitable substances (“gas source”, “O₂ gas supplier) are H₂O₂, urea-H₂O₂ adducts, percarbonates (in particular alkali metal percarbonates), perborates (in particular alkali metal perborates) and ammonium peroxydisulfate ((NH₄)₂S₂O₈). From the large industrial scale point of view, H₂O₂ is preferred since it is commercially available as a solution and can be metered easily.

If a gas source is present in composition b), a gas source activator is preferably added to composition a). A gas source activator will cause or catalyze the release of O₂ gas by chemical reaction of the gas source substance or the gas source substance mixture. For activation of the gas source, for example, potassium iodide, CoCl₂, KMnO₄, MnO₄, CuSO₄, FeSO₄, NiSO₄ and/or AgNO₃ can thus be employed as the activator.

Preferably, KI, KMnO₄, CoCl₂ and a 2:1 mixture of KMnO₄ and KI, and particularly preferably CoCl₂ are employed as the activator.

The amount of O₂ gas supplier is not particularly limited and for H₂O₂ is preferably 0 to 10, more preferably 2 to 6 wt. %, based on composition a).

The amount of e.g. perborate or percarbonate can be calculated accordingly taking into account the following principles:
1 mol of H₂O₂ releases ½ mol of O₂
mass of O₂ (m_{O2}) is obtained from m_{O2}=% H₂O₂*mₜₒₜ*(MW_{O2}/MW_{H2O2})*(½)*( 1/100) where mₜₒₜ=composition a) in g % H₂O₂=wt. % of H₂O₂, based on composition a)
alkali metal percarbonate 2 M₂CO₃.3H₂O₂: 1 mol releases 3/2 mol of O₂
m_{PC}*(3/2)*(MW_{O2}/MW_{PC})=% H₂O₂*mₜₒₜ*(MW_{O2}/MW_{H2O2})*(½)*( 1/100)
   m_{PC}=amount of percarbonate in g
   MW_{PC}=molecular weight of percarbonate
gives m_{PC}=% H₂O₂*mₜₒₜ*(MW_{O2}/MW_{H2O})*(⅓)*( 1/100)
alkali metal perborate M₂H₄B₂O₈: 1 mol releases 1 mol of O₂
M_{PB}*(MW_{O2}/MW_{PB})=% H₂O₂*Mₜₒₜ*(MW_{O2}/MW_{H2O2})*(½)*( 1/100)
   m_{PB}=amount of perborate in g
   MW_{PB}=molecular weight of perborate
gives: M_{PB}=% H₂O₂*Mₜₒₜ*(MW_{PB}/MW_{H2O2})*(½)*( 1/100)

The amount of activator is not partially limited and is preferably 0 to 0.5, more preferably 0.005 to 0.5 wt. % and still more preferably 0.002 to 0.2 wt. %, based on composition a).

Hydrogen peroxide decomposes in an alkaline medium, so that an almost complete decomposition of hydrogen peroxide typically results after approx. 30 minutes under the conditions prevailing according to the invention (such as room temperature).

This can be accelerated further by additionally using the activator.

Potassium iodide e.g., possibly in combination with KMnO₄, in an amount of from 20 to 200 mg per 100 g of composition a) has proved to be adequate for decomposition of hydrogen peroxide within a few minutes. In particular in the case of H₂O₂ decomposition in homogeneous solution (i.e. without solids in composition a) and b)) the pore formation is uniform. The formation of small pores is made possible. The viscosity of the reaction mixture increases when the pores become smaller. It is moreover sufficient to use a lower amount of activator than in all the methods described previously. The polycondensate material therefore acquires better properties because the activator will influence the polycondensation and side effects thereof to a lesser degree. CoCl₂*6H₂O can be used in still lower amounts as a decomposition activator of e.g. H₂O₂. Per 100 g of composition a) e.g. about 10 μl-100 μl of a 4.8 g/10 ml H₂O CoCl*6H₂O solution are used. That is approx. 5-50 mg per 100 g of composition a) (=2*10⁻⁴ molar). In the case of decomposition of H₂O₂ in a closed system, pressures of several bar arise in the foam product. The mixture is therefore outstandingly suitable for filling complicated structures under pressure with foam. This is a specific field of use of the invention.

Composition a) can optionally moreover comprise one or more solid components homogeneously distributed in the composition. Suitable substances are kaolin, metakaolin, SiO₂, perlites, disperse silicas, dolomite, CaCO₃, Al₂O₃ and water glass powder. These substances can be used to increase the viscosity of composition a), e.g. if a higher value than is achieved with the dissolved water glass is desired. It has moreover been found that these solids increase the resistance of the products to cracking and reduce the shrinkage during curing. The solids should be mixed in as powder, preferably having an average particle size of not more than 1 mm, more preferably not more than 100 μm.

According to one embodiment metakaolin is used (preferred particle size<20 μm). According to another embodiment a mixture of metakaolin and kaolin is used.

A mixture of water glass and metasilicate is stable for weeks, depending on the content of metasilicate, so that the corresponding components have a sufficiently long storage life. The liquids furthermore are easy to meter and mix, which can also be effected automatically. The production of foam bricks inter alia, among other foamed products, of constantly high quality is therefore ensured.

Metakaolin is a sodium aluminum silicate and can be regarded formally as a condensation product of aluminum hydroxide and silicic acid.

When aluminum is also present in the structure in addition to silicon, products of substantially higher hardness result. The inventors presume that the aluminum centers in the skeleton carry a net negative charge.

The conversion ratio of sodium silicate to metakaolin is preferably effected in a stoichiometric ratio of approximately 1:1. It is presumed that a covalent, three-dimensional network of very high stability is then formed. All sodium atoms moreover are thus used for saturating the aluminum cations. Accordingly water glass could be reacted with metakaolin in the weight ratio of 242 g to 258 g. Si:Al ratios of 2:1 and 3:1, as well as other ratios are also possible, including uneven-numbered ratios. A weight ratio of water glass to metasilicate of 100:1 to 100:25 is preferred (more preferably 100:5 to 100:25), since such mixtures are readily pourable. Nevertheless, a still higher content of metasilicate led to crumbly and to dry mixtures and is therefore not preferred in particular for producing porous shaped bodies.

Since the incorporation of aluminum tetrahedra into the lattice requires a charge compensation, corresponding cations, for example alkali metal cations, must be incorporated into the skeleton. This presumably leads to monovalent metal cations from the water glass being bonded ionically if aluminum is also incorporated. The metasilicate would then act not only as a component for building up a covalent network, but at the same time also as a curing agent. The fact that inasmuch water glass also cures in a mixture with metakaolin without further curing agents, although this can take quite a long time, is understandable inasmuch, and in the preparation of multi-component systems for producing inorganic polymers of the invention in this respect the storage time for the starting substances of the inorganic polymer to be formed is to be noted.

To further increase the compressive strength of the porous products composition a) can also comprise fibers (e.g. having a fiber thickness of <10 μm and a length of 1-10 mm), such as glass fibers, rock wool, basalt fibers and cellulose fibers, and/or glass beads (e.g. having a diameter of 1-3 mm), Styropor beads (e.g. having a diameter of 1-3 mm) and pumice particles. Their amount is not limited in particular; according to one embodiment it is 0 wt. % and according to another embodiment a suitable amount is >0 to 10 wt. %, based on composition a).

The use of phosphates in composition a) also has a favorable effect on the compressive strength of the product and can moreover reduce shrinkage during the drying process. The products obtained moreover display good rustproofing properties.

Mono-, di-, tri- or polyphosphates can be used, preferably di-, tri- and/or polyphosphates of sodium and/or aluminum. It is assumed that in addition to silicate and aluminate, polyphosphates can also be incorporated into the Si—O—Al skeleton of an inorganic polymer according to the invention. This would be particularly advantageous because in the polycondensation of water glass, as also of metasilicate, the molecules involved have in each case only two docking points and therefore without the preferred phosphates chiefly linear polymers are formed. In contrast, if a phosphate, such as, for example, trisodium phosphate (Na₃PO₄), tetrasodium diphosphate (Na₄P₂O₇) or pentasodium triphosphate, or metaphosphates, is subjected to polycondensation with silicates and aluminates, branchings in the chains can arise here.

This is due to the structure of the phosphates, cf. e.g. trisodium phosphate (Na₃PO₄):

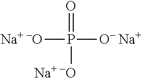

The compound tetrasodium diphosphate has, for example, four docking points, i.e. Na⁺O⁻ groups:

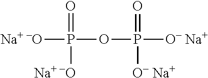

A higher number of docking points also results from trisodium phosphate and pentasodium triphosphate:

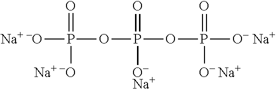

Three-dimensionally linked spatial skeletons can thus be formed.

The amount of phosphates is not limited in particular but is preferably 0 to 3 wt. %, more preferably 0 to 1 wt. %, based on composition a), and according to another embodiment>0 to 3 wt. %.

If very small bubbles and/or an overall larger and more stable foam volume is desired, it is advantageous to add a surface-active substance, i.e. a surfactant. Anionic surfactants which may be mentioned are diphenyl oxide sulfates, alkane- and alkylbenzenesulfonates, alkylnaphthalenesulfonates, olefinsulfonates, alkyl ether sulfonates, alkyl sulfates, alkyl ether sulfates, alpha-sulfo-fatty acid esters, acylaminoalkanesulfonates, acyl isothionates, alkyl ether carboxylates, N-acylsarcosinates, alkyl and alkyl ether phosphates. Nonionic surfactants which may be mention are alkylphenol polyglycol ethers, fatty alcohol polyglycol ethers, fatty acid polyglycol ethers, fatty acid alkanolamides, EO/PO block copolymers, amine oxides, glycerol fatty acid esters, sorbitan esters and alkyl polyglucosides. Cationic surfactants which may be mentioned are alkyltriammonium salts, alkylbenzyldimethylammonium salts and alkylpyridinium salts. The use of nonionic surfactants is preferred. The addition of PEG likewise proves to be advantageous, since the foaming operation proceeds more uniformly than without the addition and the foam in turn becomes more stable. It is to be mentioned that if PEG is added other surfactants can also be dispensed with completely.

The amount of surfactants is not limited in particular but is preferably 0 to 0.8 wt. %, more preferably 0.3 to 0.6 wt. %, based on composition a).

A further optional component of composition a) are oxides of polyvalent metals, preferably one or more selected from ZnO, TiO₂, MnO, PbO, PbO₂, Fe₂O₃, FeO, Fe₂O₄, ZrO₂, Cr₂O₃, CuO, BaO, SrO, BeO, CaO and MgO, and oxides of divalent metals are preferred, such as MgO, BeO, SrO, BaO, PbO, CuO, CaO, ZnO and MnO.

The admixing of metal oxide is advantageous in particular if metakaolin, which generates long chains in the polycondensation with water glass which carry negative charges on incorporation of an Al³⁺ atom, is used. Sodium or potassium cations function as the counter-charge, depending on the water glass.

If metal oxides are admixed to the reaction mixture a cation exchange can take place here. It is assumed that oxides of polyvalent metals, such as e.g. divalent metals, can serve as a bridge between two negatively charged aluminum atoms and in this way help to build up a three-dimensional network skeleton. It is to be noted in this context of course that the metal oxide admixtures do not present problems in the event of a recycling required later, and that where appropriate restrictions with respect to processability without safety regulations could occur.

Tri- or tetravalent ions, such as Fe³⁺, Cr³⁺, Z^{r4+} or Ti⁴⁺, can also be used per se as an oxide and/or sulfate. Nevertheless a cluster-like arrangement of three or more aluminum atoms is to be rated as rather improbable, so that no advantage is to be expected by ions of such higher valency.

The admixing of metal oxides of which the metals form stable, i.e. difficultly soluble, carbonates is advantageous in particular. Inorganic carbonates, such as potash and soda, are formed in the reaction with organic carbonates. If CaO, SrO, BaO, PbO, MgO or ZnO are added, later blooming of soda and potash can be avoided and at the same time the hardness and stability of the products can be increased.

The amounts of metal oxides are not limited in particular and are preferably 0 to 5 wt. %, based on composition a), and according to another embodiment>0 to 5 wt. %.

The use of alkyl siliconates (preferably C₁₋₁₈-alkyl siliconates, more preferably C₁₋₆-alkyl siliconates, such a e.g. methyl siliconate) in composition a) is likewise possible and advantageous if water-impermeable foam or the like is desired. Composite materials of water-permeable and water-impermeable foam therefore also can be produced without problems by appropriate layering of reaction mixtures, optionally carrying out the reaction of components with or without alkyl siliconate in succession.

It has furthermore been found that by employing methyl siliconate the reactions of e.g. systems with propylene carbonate which otherwise proceed very rapidly can be delayed. There may be mentioned here as the methyl siliconate e.g. potassium methyl siliconate, e.g. Rhodorsil Siliconate 51T from Rhodia. However, the delay may also be helpful in order to allow extensive foaming and therefore a low density.

The amount of alkyl siliconates is not limited in particular and is preferably 0 to 10 wt. %, more preferably 0.1 to 5 wt. %, based on composition a).

In order to increase the strength of the products alkali metal and/or alkaline earth metal sulfates can also be added, preferably barium, calcium and/or lithium sulfate. Their amount is not limited in particular and is preferably 0 to 2 wt. % (according to one embodiment>0 to 2 wt. %), based on composition a).

Organic or inorganic pigments can of course also be added to composition a) if colored products are desired.

In step c) of the method according to the invention compositions a) and b) are brought into contact in order to allow the polycondensation to proceed. If solids such as pigments and others are not additionally present in compositions a) and b) a homogeneous fluid is can be reacted. This is advantageous because the polycondensation reaction can therefore likewise take place from a homogeneous solution. The involved stirring of suspensions can therefore as a rule be dispensed with. This allows, for example, the use of appropriately on-site construction foaming from spray cans, spray guns etc., especially since the components are not only curable more rapidly, but also non-combustible. The fact that, as can be seen from the above, chemicals which are toxic or a health hazard do not have to be employed also allow in this context use indoors or in interior construction. It is to be mentioned, however, that solids which solidify from a homogeneous solution tend towards greater shrinkage. If a dimensional stability during curing is not absolutely necessary, this is not critical. Otherwise, the shrinkage can be reduced or avoided completely if the polycondensation is carried out in a suspension.

No external supply of heat is necessary for the reaction. Depending on the constituents and amounts used, a foam which solidifies is formed within seconds to minutes. The final strength is achieved by storage at room temperature for some days.

If other constituents are also used in addition to the water glass and curing agent (I), the method according to the invention proceeds by way of example as follows:
(1) Provision of a water glass solution
(2) Optionally adding an activator solution (e.g. CoCl₂ solution)
(3) Optionally adding solids, such as e.g. metakaolin, and homogeneous distribution by stirring
(4) Optionally adding oxide of a polyvalent metal, such as e.g. ZnO, TiO₂
(5) Optionally adding a surfactant, e.g. a nonionic surfactant, and optionally a phosphate
A stable solution or suspension A is obtained.
(6) Provision of a carbonate curing agent solution
(7) Optionally adding a gas source, e.g. H₂O₂, to the carbonate curing agent solution
(8) Addition of the carbonate curing agent solution to solution or suspension A, optionally with stirring.

The foaming can be carried out in a mold. The solidified porous body is then removed from the mold.

The foaming can be carried out in a hollow cavity, e.g. bore hole, and the foamed and solidified product can remain therein.

The foaming can be carried out outside a mold and the solidified mass can be brought into a particular shape afterwards by working, such as sawing, grinding etc.

The products obtained with the method according to the invention are solidified foams (here also called porous masses or porous shaped bodies) which are distinguished by both a high strength and good thermal insulation properties. They moreover display a high heat resistance.

The products can have closed and/or open pores. While products which have been produced using a gas source, such as H₂O₂, display predominantly closed pores, products which have been produced without a gas source display a mainly open pore system.

By controlling the method parameters (e.g. use of surfactant, choice and amount of curing agent) pores of different size can be generated; e.g. average pore diameters of 40-300 μm, in particular 60 to 140 μm, or 70-90 μm can be achieved.

The percentage pore area P_{A} can be determined as described below and for the products according to the invention fulfills the following condition:

0.5<P_{A}<1

The porosity of the products obtained likewise can be controlled via the method parameters and is preferably 40-95%, more preferably 50-92%, particularly preferably 65-85%, in each case determined using the method described below. A porosity above 95% means at the same time a reduced strength and is therefore not desirable for some uses.

The density of the products obtained is preferably 0.05-0.5 g/cm³, more preferably 0.1-0.4 g/cm³, determined using the method described below.

### Determination of the Percentage Pore Size

Immediately after being brought into contact, a reaction mixture (i.e. composition a) and b) mixed together) was poured on to a glass plate where a cured mass was formed, and this was removed from the glass plate after curing. With the flat side (i.e. the cured side in contact with the glass plate) of the cured sample on top, the sample was laid under an optical microscope and an image of the flat sample side was produced with 100-200 times magnification under illumination from the side. The pores of the sample were then detectable on the flat surface here. (1) The total area of the sample was calculated (corresponds to the length×width of the image) and (2) the area of all the pores visible on the image was measured. The percentage pore area was calculated according to the following equation

P_{A}=Total area of all the pores on the image/Total area of the image×100%

### Determination of the Porosity

A test specimen was produced in the form of a right parallelepiped having edge lengths of 6×3.5×3.5 cm and was dried to constant weight at room temperature. The specimen was weighed (G_{before} in g) and then immersed completely in aqueous soap solution (10 drops of commercially available detergent in 1 l of distilled water) for 1 h, during which the vessel was closed with a lid.

The test specimen was then removed from the vessel and after the liquid had dripped off was weighed again, whereby G_{after} in g was determined. The porosity P was determined according to equation (2):

$$P = \frac{{G}_{after} - {G}_{before}}{Specimen volume • Density} \times 100 ( \% ) \qquad ( 2 )$$

wherein 73.5 cm is used for the specimen volume and 1 g/cm³ for the density, so that equation (2a) is obtained:

$$P = \frac{{G}_{after} - {G}_{before}}{73.5} \times 100 ( \% ) \qquad ( 2 a )$$

### Determination of the Density

For determination of the density the volume and the weight of a rectangular test specimen was determined and the density was calculated as weight/volume.

### Determination of the Thermal Conductivity

For determination of the thermal conductivity test specimens having a thickness of 3.5 cm together with a reference specimen of the same thickness and a thermal conductivity of 0.0354 W/mK (obtainable from IRMM=Institute for Reference Materials and Measurements, Geel, Belgium) were laid on a hot plate at a constant temperature of 80° C. for 1 h and then measured in the dark with a thermal imaging camera. The thermal conductivity of the test specimen was determined with the aid of the reference specimen via the surface temperature measured (as a measure of the thermal conductivity) on the test specimen.

### Determination of the Compressive Strength

The compressive strength of the samples was measured with a 2250 universal testing machine from Zwick/Roell. For this the compressive forces (in N) were recorded as a graph over the deformation zone. The maximum pressure achieved was related to the surface area of the sample and stated as N/mm² (=MPa).

The product obtained by the method according to the invention has a plurality of uses. It can be employed as a thermal or low temperature insulating material, in particular in house construction, in industrial construction, in furnace construction and/or in thermal insulation construction.

Foam bricks or foam brick elements, in particular water-repellant foam bricks, structural elements for tunnel construction, plasters, pipes and/or pontoon bricks can be produced. If the foam is sufficiently open-celled, fuel, such as ethanol, can be accommodated in the polymer product, which allows the use as a fuel store, for example in burners or the like. The accommodation of ethanol in the foam bricks and therefore the use thereof as a fuel which can be metered can be advantageous for burners, fireplaces and the like. The use as rock wool, for rapid prototyping (rapid production of sample components), computer-generated casting molds, but also as room coolants, in particular as an agent which has a room-cooling action by uptake and release of water, as well as the production of composite materials (e.g. with at least in each case one water-retaining and one water-permeable layer) may be mentioned. Usability as a passive room humidifier can also be seen from the above.

It is further to be mentioned that use of material produced according to the invention also as footstep sound insulation, as planking or lining of visible surfaces, for screeds, for producing pipes is possible, products can be employed for fireproofing purposes (wherein this fireproof material is acid-resistant, mineral and lightweight), for internal and external insulation purposes, in particular as internal and external insulation, as fire-resistant door foam and/or as a filler for dispatch of hazardous goods, such as acids, where it offers particular advantages due to its absorbency optionally provided during production. The absorbency in particular of foams according to the invention appropriately produced with open pores also allows the use of granules of such material produced according to the invention as a binder for oil spills.

It is possible for prefabricated elements such as walls, ceilings, façade sheets, soundproof walls, fireproof walls to be produced according to the invention and/or bricks similar to porous concrete to be produced, which furthermore can be adjusted in strength and at the same time can have a higher resistance to acid than porous concrete. For construction purposes the fact that glass fibers, glass fiber constructions, carbon fibers and structures which can enter into a polymeric bond can be employed can be advantageously utilized. High strengths of more than 30 N/mm² can be achieved in this way, and in particular components which thanks to their high strengths can be employed simultaneously for insulation and reinforcement can be produced. It is particularly advantageous in this context that the material can be repaired where appropriate, without losing its positive properties such as strength and resistance. It is to be mentioned that where appropriate curing can also take place under water, which offers significant advantages in particular cases of use.

The material can also be used as a porcelain adhesive, core insulator in bricks for prefabricated elements, such as walls, ceilings, façade sheets, soundproof walls, fireproof walls etc.

If granules or very fine powders are to be produced, foam can also be generated in a spray tower where appropriate. This can render it possible to produce a lightweight filler of high mechanical stability. The pulverulently or finely ground material bodies are suitable as fire extinguishing agents at high temperatures and it is moreover possible to use a rapid-foaming, fine-pored variant for producing fire barriers for surface fires, such as forest fires, where the very large increase in volume is just as advantageous as the fact that in the event of fire less combustible material has to be eliminated. The use as fire barriers is furthermore also advantageous because not only does the material of the present invention have a high heat resistance and a high melting point, the material itself does not represent special waste after passing through a fire. The fact that this is also advantageous in the case of conventional use in residential properties and the like is also to be mentioned.

It is moreover to be emphasized that in addition to the use in large pieces, such as for prefabricated parts, the use of a foam produced according to the invention e.g. as a product from a spray tower and/or in ground or, as granules, in shredded form is also possible, for example as a filler for lightweight concrete, for plasters, in particular silicate plasters, as a substitute for Styropor e.g. in bricks, i.e. for use as a filler for improving the thermal insulation properties of bricks and the like or other laggings or building materials. A powder, ground or shredded foam of the invention can also be employed as an addition for concrete, wherein the concrete gains resistance towards attacks by acid with the filler according to the invention. An appropriately treated concrete can be employed in particular in bridge construction, road construction, for sewage pipes etc. The fact that ground or shredded silicate foam or powder can be employed as bulk material before laying flooring between girders, for example in renovation of old buildings, and in renovation of fireplaces with a stainless steel tube between the pipe and chimney wall is to be mentioned.

The products are stable to acid, resistant to fungi, heat-resistant up to typically 1,600° C.; moreover, they can be sawn and/or ground, milled and nailed without cracking occurring.

A further use is also the use as a catalyst support. Thus it would be possible e.g. to co-foam metal nitrates. The metal nitrates will react with the alkali metal carbonates liberated during the polymer formation to give metal carbonates, and these can be converted into catalytically active metal oxides at high temperatures. Good catalysts thus result.

The use of lead oxides, i.e. PbO and PbO₂, allows (preferably) non-foamed pouring in of radioactive waste for permanent storage because of the high stability of the end product. This is far more favorable in terms of energy than the vitrification practised hitherto.

The heat resistance and dimensional stability up to about 1,600° C. makes the product usable for furnace construction, but also in the field of fireproofing safety etc. The foam bricks furthermore show a high stability towards compressive and shearing forces, which also allows them to be used for earthquake-proof buildings. The stability can be increased further by the addition of fiber materials. Since not only can the products be sawn, ground and/or drilled, but nails can also be driven in without cracking, they are very readily processable. With appropriate foaming the densities are so low that pontoon bricks can be constructed, and moreover the use of for the production of acid-stable vessels, containers and pipes, for example for collecting tanks and the like, is possible. The addition of alkyl siliconates also allows the use in the ground region. It is possible without problems to combine compositions a) and b) from spray cans or the like and in this way to use them for filling e.g. hollow cavities such as bore holes with foam.

The material produced according to the invention also has a very good adhesiveness which is better on walls than in the case of plaster. The material also adheres very well to iron supports and galvanized surfaces. By using phosphates rustproofing properties result at the same time here. The high heat resistance and the fact that the mixtures can be readily spun also allows the production of fire-resistant rock wools.

A product can be colored with colored pigments without problems.

Due to the rapid rate of reaction the system is particularly suitable for rapid prototyping. In such a use the viscosity is typically chosen only low enough for it to be possible for the components still to be brought out of a reservoir in a well-controlled manner. If the products are to be used for passive room cooling such that the finished materials take up water and withdraw water from the environment on evaporation, the products can be configured with agents which inhibit formation of algae if the products are to be arranged visibly.

The products of an inorganic polymer which are obtained according to the invention comprise no combustible constituents (if combustible organic materials, such as e.g. cellulose fibers, have not been mixed in) and are thus completely recyclable.

In contrast to known polymeric reactions, the reaction claimed here proceeds with a lowering of the pH. In contrast to the conventional method, protons and not hydroxyl anions serve as a catalyst for the polycondensation. The corresponding reactions proceed significantly faster than in the case of conventional polycondensation and they can proceed at room temperature. The general problem in the production of inorganic foams, namely the too long a time for curing, can thus be avoided.

A skeleton which is sufficiently stable at elevated temperatures can be produced by the method according to the invention. In this context a skeleton stability should exist without problems up to above 650° C., typically even up to about 1,600° C., because the end product comprises neither—as in Portland cement—water nor—as in air-hardening mortar—calcium carbonate, so that at higher temperatures neither escaping water nor escaping carbon dioxide can destroy the structures.

It is to be pointed out that the porosity of the end product can be adjusted via various parameters of the method according to the invention, e.g. curing agent, additives, ratio of water glass/metakaolin, amounts, so that materials of different density can be produced. Pores of the products can be established in this context in the range of from a few μm to cm. This is advantageous, since the insulating action of insulators is based on the inclusion of air in the form of small bubbles, for which reason all known thermal insulating materials are porous to a high degree.

Non-mineral thermal insulating materials, such as polystyrene, polyurethane and wool, but also rock wool, usually have a total porosity of at least 45%. Values of from 60 to 90% are found in practice, and in the extreme case (in aerogels) also up to 99%. A high porosity renders possible a high gas permeability, but unfortunately always also reduces the mechanical strength of the material.

Conduction by solids, convection and radiation are responsible for heat flow. All three parameters display a temperature-dependent influence to different degrees. Air convection should be avoided in any event in insulating materials. Pore diameters of <1 mm are desirable in order to achieve a heat flow which is as low as possible, since the free path length of air molecules at room temperature is 68 nm. Generally, the lighter in weight the material and the smaller the pores thereof, the better the material can hold back heat. A uniform pore distribution is important. Bricks having a small, uniform pore dimension should hold back heat to the optimum. A uniform pore distribution can be established in particular from homogeneous solution.

The reaction mixture of the invention can also be spun, so that wool-like materials result; the mixture of composition a) and b) can be applied as plaster, in particular as thermal insulation plaster, before curing, and the use of the mixture in rapid prototyping is possible.

Because of the particular heat stability up to 1,600° C., a use of the masses according to the invention in foundry technology is also possible.

Casting of metals is a primary forming process in which liquid metal is poured into a hollow mold in order to form a cast body corresponding to the mold. The production of cast bodies, in particular of large and complex cast bodies, presents considerable problems. The liquid, hot metal must in fact completely fill the hollow body so that no shrinkage cavities and the like are formed. For this, however, it must be ensured that when the hot, liquid metal cools and a reduction in volume accordingly occurs there is also still enough material available to ensure complete filling even when the hot material contracts. For this reason reservoir volume are provided, into which additional liquid hot metal is poured, which subsequently flows into the hollow body in the course of filling of the hollow body and during cooling of the material. It must also be ensured that where appropriate air can escape.

The hot metal now not only leads to a sudden heating of the materials coming into contact with the metal, but also because of the high density of the metal at the same time exerts high forces which the material severely heated locally must also withstand during the flowing in of metal. It is furthermore advantageous if the removal of heat from the metal into the volume of the mold material is only low precisely in feeders, pouring channels etc. Otherwise, if the outflow of heat is too high proper subsequent flowing of the material into the hollow body mold cannot be ensured. For this reason precisely for the reservoirs, called risers, for liquid metal, but where appropriate also at other places, it is advantageous to use a material which is insulating.

For the purposes of the present application foundry auxiliary bodies are understood, inter alia, as meaning feeders, pouring channels to the hollow cavity actually to be molded from, cores which are provided in a casting mold in order to form hollow cavities there in turn and etc. Pouring systems also include so-called breaker cores, pouring-runner-gate systems, such as channels for pouring in, hoppers for pouring in, gates for distributing the liquid metal in the hollow cavity of the mold etc. These individual parts can be combined where appropriate, that is to say do not necessarily have to be produced from one piece in the mold construction. There are moreover further foundry auxiliary bodies, for example pouring filters for the metal to be poured in, in order to filter out contamination etc. present there.

It is known to employ water glass in mold construction. It is thus referred to in DE 10 2007 031 376 A1 that binders containing water glass can be used for binding the foundry sand used for mold construction, wherein it is mentioned that the casting mold can be produced by the water glass/ester method.

Due to their high heat resistance, their strength and their good recyclability, the masses/shaped bodies produced according to the invention are outstandingly suitable for foundry auxiliary bodies. In this context it is possible in principle to configure the foundry auxiliary body such that it also withstands high pouring forces. The foundry auxiliary body in this context comprises the mass according to the invention in at least one region flowed into during the casting operation.

Very fine-pored or compact body surfaces which can be realized with the method according to the invention are desired for contact with molten metal precisely on the inside. Such surfaces can be realized e.g. by lining with material which is not foamed or foamed to a lesser extent; since the material bonds very well during multistage production, these possibilities are opened up. As can be seen from the above, additions are possible in principle. It is to be mentioned that in addition to relatively small foundry auxiliary bodies, such as pouring hoppers, feeders etc., larger auxiliary bodies can also be produced, e.g. hollow molds themselves, which are possibly even reinforced accordingly later, for example with carbon nanotubes, glass fibers etc.

The high heat resistance of the masses/shaped bodies obtained according to the invention allows the use also with high-melting alloys. In this context it is of great advantage that the foundry auxiliary body is subjected to only a small change in size, can be produced without cracks and in this context also still has a sufficiently high mechanical stability under the influence of heat; the foundry auxiliaries moreover are distinguished by good insulating properties and resistance to attack by mineral acid. However, it is to be pointed out that for example if the riser or the like is to be configured as an exothermic foundry auxiliary body, for example in which combustible substances are incorporated, there is no resistance to mineral acid because the exothermically reacting additions also react with the mineral acids.

It is possible that the foundry auxiliary body is formed completely from mass according to the invention with or without additives, fiber reinforcements and/or aggregates. In this context there may be exceptions with respect to at any rate one or more of the elements of filter regions in particular pouring filter regions, in particular large- and/or open-pored, foamed, inlaid and/or integrally connected filter regions, connecting regions for connecting with one of the other elements of a casting mold and/or other foundry auxiliary bodies, covers, regions for exothermic reactions.

It is possible in particular to provide filter regions. Pouring filters serve to filter coarse impurities out of the liquid metal to be cast. This is possible with the material according to the invention if this is produced as open-pored with large pores by appropriate control of the production process. This in turn can be effected e.g. by carrying out a pressure-free foaming instead of a foaming under pressure, which results in small pores. The corresponding regions can then form the base of a pouring body or be laid in such a body.

It is to be mentioned that a foundry auxiliary body is preferably selected from one of riser (also called feeder), pouring system, pouring channel, casting hopper and entry system.

According to one embodiment the foundry auxiliary body is characterized in that material having a pore size of <3 mm, preferably ≦2 mm, is present in at least one region. Preferably, the foundry auxiliary body has a density below 0.4 kg/l.

According to one embodiment the foundry auxiliary body is characterized in that with the exception of one or more elements selected from filter regions (e.g. pouring filter regions, in particular large- and/or open-pored, foamed, inlaid and/or integrally connected filter regions), connecting regions (for connecting with one selected from other elements, a casting mold and/or other foundry auxiliary bodies and covers) and regions for exothermic reactions, it is formed completely from mass according to the invention.

Potash water glasses are preferably employed for producing foundry auxiliary bodies such as e.g. feeders, and indeed particularly preferably a mixture of 2 different potash water glasses having a different water content, for example a mixture of 20 wt. % of potash water glass where s=2.2 and 80 wt. % of potash water glass where s=1.35. The use of potash water glass has advantages in this context in particular with respect to curing time and the time to solidification, which in turn is capable of influencing the bubble size.

It is preferable to add solids, particularly preferably kaolin and metakaolin, in the mixture. Metakaolin is bonded chemically and thus modifies the strength. Kaolin, on the other hand, primarily modifies the viscosity before the reaction and prevents shrinking. A lower shrinkage can thus be ensured with this, and foaming and the reaction program can be influenced with the viscosity of the components. The weight mixing ratio of kaolin/metakaolin is preferably 1:9 to 9:1, preferably 2:8 to 8:2 and particularly preferably 1:1. It is to be pointed out at the same time that it is also possible to use only kaolin alone, but a mixture of kaolin and metakaolin is preferable with respect to pore sizes which can be achieved.

Some embodiments of the present invention are summarized in the following:
1. A method for producing a porous mass or a porous shaped body of inorganic polymer, comprising
   a) providing an aqueous composition comprising sodium and/or potassium water glass dissolved in water, wherein the composition has a pH of at least 12
   b) providing a composition comprising
      (i) water, wherein the amount of water is chosen such that

$$\frac{{m}_{WG}}{{G}_{a} + {G}_{b}} \times 100 \% \geq 25 \%$$

Gₐ=weight of composition provided in a) in g
G_{b}=weight of composition provided in b) in g
m_{WG}=amount of dissolved water glass in g in the composition provided in a)
and
(ii) at least one water-soluble or water-miscible curing agent, wherein the curing agent is selected from carbonates of the general formula (I)

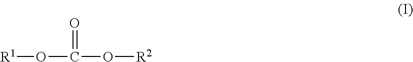

wherein R¹ and R² independently of each other are selected from C₁₋₆ alkyl optionally substituted by one or more OH groups, or R¹ and R² together with the group

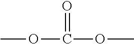

form a 5-membered ring which is optionally mono- or polysubstituted by substituents selected from C₁₋₂ alkyl and C₁₋₂ alkyl substituted by one or more OH;
and wherein the amount of carbonate m_{C} in g employed is from mₛₜₒ to x*mₛₜₒ
where
   x=0.35 if dissolved Na water glass is used in a) and
   x=0.45 if dissolved K water glass is used in a)
   and
   x=0.35*y_{Na}+0.45*y_{K} if a mixture of dissolved Na water glass and dissolved K water glass is used in a), wherein
y_{Na}=weight ratio of Na water glass, based on the total amount of dissolved water glass, calculated from:
(amount in g of the dissolved Na water glass)/(total amount in g of dissolved water glass)
y_{K}=weight ratio of K water glass, based on the total amount of dissolved water glass,
wherein y_{Na}+y_{K}=1,
wherein mₛₜₒ is calculated according to the following equation (1)

mₛₜₒ=(MW_{C}/MW_{M}_{₂}_{O})*(m_{wG}/(1+s)) (1)
where mₛₜₒ=stoichiometrically required amount of carbonate in g
MW_{C}=molecular weight of the carbonate used
MW_{M}_{₂}_{O}=molecular weight of M₂O from the dissolved water glass, where M=Na or K
m_{WG}=amount of dissolved water glass in g in the composition provided in a)
s=weight ratio SiO₂/M₂O of the water glass used in a)
and wherein if a mixture of 2 or more water glasses is employed

mₛₜₒ=Σmₛₜₒ(i) (2)
and mₛₜₒ(i) is the amount of carbonate calculated according to equation (1) for each water glass (i) with the particular s(i) value; and wherein if carbonate mixtures are used, for MW_{C} in equation (1)

Σ(MW_{C}(i)*m(i)) (3)
is used
where MW_{C}(i)=molecular weight of carbonate (i)
   m(i)=weight ratio of carbonate (i), based
on the total amount of carbonate curing agents used
wherein Σm(i)=1
and
c) bringing into contact, without supplying heat, the aqueous compositions provided in step a) and b) in order to achieve a polycondensation.
2. The method according to item 1, wherein the composition provided in b) additionally comprises at least one substance in dissolved form which releases O₂ by decomposition.
3. The method according to item 2, wherein the substance releasing O₂ on decomposition is selected from H₂O₂, urea-H₂O₂ adducts, ammonium peroxydisulfate (NH₄)₂S₂O₈, percarbonates, perborates and mixtures thereof.
4. The method according to item 3, wherein the substance releasing O₂ on decomposition is selected from H₂O₂, alkali metal perborates, alkali metal percarbonates and mixtures thereof.
5. The method according to any of items 2-4, wherein the substance releasing O₂ on decomposition is H₂O₂, which is employed in an amount of from 2 to 10 wt. %, based on composition a).
6. The method according to any of items 2 to 5, wherein the composition provided in a) additionally comprises at least one dissolved or suspended activator for releasing of O₂, the activity of which can be increased by addition of alkali metal hydroxide.
7. The method according to item 6, wherein the activator is selected from KI, CoCl₂, KMnO₄, MnO₄, CuSO₄, FeSO₄, NiSO₄, AgNO₂ and mixtures of 2 or more of the above.
8. The method according to item 7, wherein the activator is selected from KI, KMnO₄, CoCl₂ and a 2:1 mixture of KMnO₄ and KI.
9. The method according to any of items 6 to 8, wherein the activator is employed in an amount of from 0 to 0.5 wt. %, based on composition a).
10. The method according to one of the preceding items, wherein the composition provided in a) moreover comprises one or more solid components selected from kaolin, metakaolin, SiO₂, perlites, disperse silicic acids, dolomite, CaCO₃, Al₂O₃ and water glass powder, in homogeneously distributed form.
11. The method according to item 10, wherein the composition provided in a) comprises metakaolin.
12. The method according to item 11, wherein the weight ratio of dissolved water glass to metakaolin is 100:1 to 100:25.
13. The method according to any of the preceding items, wherein the composition provided in a) moreover comprises one or more components selected from glass fibers, rock wool, basalt fibers, cellulose fibers, pumice, glass beads and styropor beads, in homogeneously distributed form.
14. The method according to item 13, wherein the fibers or particles are contained in composition a) in an amount of from 0 to 10 wt. %, based on composition a).
15. The method according to any of the preceding items, wherein the composition provided in a) moreover comprises one or more oxides of polyvalent metals.
16. The method according to item 15, wherein the oxides are one or more selected from ZnO, TiO₂, MnO, PbO, PbO₂, Fe₂O₃, FeO, Fe₃O₄, ZrO₂, Cr₂O₃, CuO, BaO, SrO, BeO, MgO and CaO.
17. The method according to item 15 or 16, wherein the oxide is an oxide of divalent metals or mixtures thereof.
18. The method according to item 15 to 17, wherein the oxides are contained in an amount of from 0 to 5 wt. %, based on composition a).
19. The method according to any of the preceding items, wherein the composition provided in a) moreover comprises one or more sulfates selected from alkali metal sulfates and alkaline earth metal sulfates.
20. The method according to item 19, wherein the sulfates are present in an amount of from 0 to 5 wt. %, based on composition a).
21. The method according to any of the preceding items, wherein the composition provided in a) moreover comprises one or more surface-active substances.
22. The method according to item 21, wherein one or more nonionic surfactants are used.
23. The method according to item 21 or 22, wherein the surfactants are present in an amount of from 0 to 0.8 wt. %, based on composition a).
24. The method according to any of the preceding items, wherein the composition provided in a) moreover comprises one or more phosphates selected from mono-, di-, tri- and polyphosphates.
25. The method according to item 24, wherein the phosphate is selected from di-, tri- or polyphosphates of sodium or aluminum and mixtures of 2 or more thereof.
26. The method according to item 24 or 25, wherein the phosphates are present in an amount of from 0 to 3 wt. %, based on composition a).
27. The method according to any of the preceding items, wherein the composition provided in a) moreover comprises one or more alkyl siliconates.
28. The method according to item 27, wherein the alkyl siliconates are present in an amount of from 0 to 10 wt. %, based on composition a).
29. The method according to any of the preceding items, wherein the curing agent is at least one from ethylene carbonate, propylene carbonate, butylene carbonate, dimethyl carbonate and glycerol carbonate.
30. The method according to any of the preceding items, wherein the dissolved water glass in the composition provided in a) is potassium water glass or a 50:50 mixture of sodium water glass and potassium water glass.
31. The method according to any of the preceding items, wherein the dissolved water glass in the composition provided in a) is at least one water glass for which:
   Q₁: 2-6%
   Q₂: 10-25%
   Q₃: 15-25%
   Q₄: 45-70%
      wherein the area of that peak assigned to a particular silicon group Q(i) is related to the sum of the areas of all the Si NMR signals (=100%).
32. The method according to any of the preceding items, wherein the dissolved water glass in the composition provided in a) is a mixture of water glasses and the ratio of water glass having an s value of from 1.3 to 5 is at least 90%, based on the total amount of dissolved water glass.
33. The method according to any of the preceding items, wherein composition a) moreover comprises an organic pigment.
34. A porous mass or shaped body obtainable by the method according to any of items 1 to 33.
35. A porous mass or shaped body of polycondensed sodium and/or potassium water glass, characterized in that the pores are homogeneously distributed and the porosity is 40 to 95%.
36. The porous mass or shaped body according to item
35, wherein the porosity is 65 to 85%.
37. The porous mass or shaped body according to any of items 34 to 36, wherein the density of the mass/porous body is 0.05 to 0.5 g/cm³.
38. The porous mass or shaped body according to any of items 34 to 37, wherein the percentage pore area P_{A}, calculated as (area of all the pores on an optical microscope photograph)/(total area of the optical microscope photograph) applies:

0.5<P_{A}<1.
39. A use of the porous mass or the porous shaped body according to any of items 34 to 38 as insulating material, foam brick, for foundry auxiliary bodies, material for fire- and soundproof walls, injection material for hollow cavities, catalyst support, material for thin layer or column chromatography or for rapid prototyping.
40. A foundry auxiliary body which comprises a porous mass according to any of items 34 to 38 in at least one region flowed into during the casting operation.
41. The foundry auxiliary body according to item 40, wherein this is a feeder, casting hopper, pouring channel, a pouring system, entry system or a casting core.
42. A composite material, characterized in that a part thereof is made of a porous mass according to any of items 34 to 38.

The invention is explained in the following with the aid of examples and with reference to the figures, but is in no way at all limited thereto.

Experimental Part

Chemicals Used:

Sodium water glass: s=3.3, sₘₒₗₐᵣ=3.4, Roth (Karlsruhe, D), aqueous solution with 34.5% solid content (Na7561)

Sodium water glass 38/40: s=3.3, sₘₒₗₐᵣ=3.4, Woellner (Ludwigshafen, D), aqueous solution with 36% solid content (Na38/40)

Potassium water glass Betol 5020T: s=1.35, sₘₒₗₐᵣ=2.2, Woellner (Ludwigshafen, D), aqueous solution with 48% solid content (K5020)

Potassium water glass Betolin K35: s=2.2, sₘₒₗₐᵣ=3.4, Woellner (Ludwigshafen, D), aqueous solution with 35% solid content (K35)

Potassium water glass K42: s=1.9, sₘₒₗₐᵣ=2.9, Woellner (Ludwigshafen, D), aqueous solution with 40% solid content (K42)

The characterization of the structure of the water glasses used by ²⁹Si MAS-NMR (carried out as described below) is to be found in Table 1:

TABLE 1

| | | | | | | % solid |
|---|---|---|---|---|---|---|
| Name | Q₀ | Q₁ | Q₂ | Q₃ | Q₄ | content |
| K50/20 | 0.71 | 5.6 | 21.3 | 23.6 | 48.8 | 48.0 |
| K42 | 0.36 | 3.3 | 13.3 | 18.7 | 64.3 | 40.0 |
| Na38/40 | 0.3 | 2.2 | 11.6 | 20.5 | 65.4 | 36.0 |
| K35 | 0.2 | 2.6 | 10.9 | 18.8 | 67.5 | 35.0 |
| Na7561 | 0.17 | 2.1 | 9.5 | 17.4 | 70.8 | 34.5 |

Metakaolin: MetaStar 501, Lehmann and Voss (Hamburg, D)

Pentasodium triphosphate (Na₅P₃O₁₀): white, odorless solid of molecular weight 367.86 g/mol and density 2.52 g/cm³, from Roth (Karlsruhe, D); solubility in water at 25° C. 145 g/l

Propylene carbonate (curing agent): specific density of 1.21 g/cm³. Solubility in water 240 g/1; from Merck (Darmstadt, D)

Glycerol carbonate (curing agent): specific density of 1.40 g/cm³; miscible with water; from ABCR GmbH (Karlsruhe, D.)

Hydrogen peroxide (oxygen source): from Merck, Darmstadt, 35% solution

Sodium perborate (oxygen source): from Fluka (Bucks, CH)

Cobalt chloride CoCl₂×6H₂O (activator): Merck, Darmstadt

Triton BG-10 (nonionic surfactant): Dow Chemical (Midland, USA)

Zinc oxide and titanium oxide: Merck (Darmstadt)

Rhodorsil® Siliconate R 51T: methyl siliconate, Rhodia (Freiburg, D) (R 51T)

Lithopix S2: solid water glass, Tschimmer & Schwarz GmbH & Co. KG (Lahnstein, D)

Sipernat: solid silicic acid

The following standard solutions were prepared:

Cobalt solution: 4.8 g of CoCl₂*6H₂O, dissolved in 10 ml of H₂O (2*10⁻² mol)

KMnO₄/KI suspension: 0.6 g of KMnO₄+0.3 g of KI in 10 ml of H₂O

Triphosphate solution: 13 g of pentasodium triphosphate, dissolved in 100 ml of water

Surfactant solution A: 1 g of Triton BG-10 is dissolved in 100 ml of water with 13 g of pentasodium triphosphate

Surfactant solution B: 20 g of Triton BG-10 is dissolved in 100 ml of water

Perborate solution: 0.9 g of sodium perborate is dissolved in 100 ml of water.

### Examples 1-10

100 μl of cobalt solution were added to 5 ml of water. 1 to 3 drops of water glass solution (the commercially obtained aqueous solution of the water glass mentioned first in Table 2 in the particular example from the top downwards was used) were then added with gentle shaking. The solution was deep blue and clear. The solids mentioned in Table 2 for the particular example from the top downwards, in succession, optionally water and finally 5 ml of surfactant solution B were added to this solution.

The mixture obtained was stirred at 400 rpm for 10 min. A clear solution of propylene carbonate (curing agent) and 30% H₂O₂ solution (for the amounts see Table 2) was then added rapidly, while stirring. The mixture then foamed within 15 seconds and was pourable for 20-40 seconds. It was poured into a mold (24×12×6=1,728 cm³), cured rapidly and could be removed from the mold after 10-20 minutes. The final hardness was reached after 6-8 days.

In Example 10 the KMnO₄/KI suspension was used instead of the cobalt solution and this was mixed in with surfactant B only at the end.

The details with respect to the chemicals employed and amounts thereof (in g) and properties of the products obtained are to be found in Table 2. The pH of the water glass mixture (composition a) before addition of the curing agent) was between 12 and 12.5 in all the examples; viscosities are stated in Table 2.

TABLE 2

| Example | 1 | 2 | 3 | 4 | 5 | 6 | 7 | 8 | 9 | 10 |
|---|---|---|---|---|---|---|---|---|---|---|
| K42 | 325 | 250 | 200 | 300 | — | 150 | 100 | — | 172 | — |
| [g] | | | | | | | | | | |
| K35 | 325 | — | 200 | 300 | 60 | 150 | — | 280 | 172 | 50 |
| [g] | | | | | | | | | | |
| K5020T | — | — | — | — | 242 | — | — | 90 | — | 200 |
| [g] | | | | | | | | | | |
| Na7561 | — | 250 | — | — | — | — | 100 | — | — | — |
| [g] | | | | | | | | | | |
| Na38/40 | — | — | — | — | — | — | — | 280 | — | — |
| [g] | | | | | | | | | | |
| R51T | — | — | 13 | — | 10 | 10 | — | — | 12 | — |
| [g] | | | | | | | | | | |
| Perlite | 42 | — | 8 | — | — | 6 | — | — | — | — |
| [g] | | | | | | | | | | |
| Metakaolin | — | 20 | — | — | 58 | — | 8.5 | 14 | — | 50 |
| [g] | | | | | | | | | | |
| Lithopix | — | — | — | — | — | — | — | — | 13 | — |
| [g] | | | | | | | | | | |
| Sipernat | — | — | — | 15 | — | — | — | — | — | — |
| [g] | | | | | | | | | | |
| ZnO | 3 | 5 | 2 | 2 | 2 | 2 | 2 | 2 | 3 | — |
| [g] | | | | | | | | | | |
| H₂O | — | — | — | — | — | — | — | 100 | — | 10 |
| [ml] | | | | | | | | | | |
| Viscosity in | 130 | 130 | 40 | 80 | 790 | 10 | 90 | 24 | 10 | 320 |
| mPa · s¹⁾ | | | | | | | | | | |
| Curing | 63 | 49 | 40 | 58 | 40 | 30 | 20 | 68 | 32 | 24 |
| agent | | | | | | | | | | |
| [ml] | | | | | | | | | | |
| H₂O₂ | 18 | 22 | 20 | 17 | 15 | 15 | 9 | 14 | 20 | 25 |
| [ml] | | | | | | | | | | |
| Density | 0.216 | 0.214 | 0.117 | 0.256 | 0.185 | 0.131 | 0.111 | 0.31 | 0.137 | 0.130 |
| g/ml | | | | | | | | | | |
| Thermal | 0.053 | 0.054 | 0.044 | 0.055 | 0.074 | 0.044 | 0.056 | 0.055 | 0.041 | 0.031 |
| conductivity | | | | | | | | | | |
| W/mK | | | | | | | | | | |
| Compressive | 0.46 | 0.88 | 0.06 | 0.69 | 0.39 | 0.39 | 0.15 | 0.43 | 0.43 | 0.08 |
| strength | | | | | | | | | | |
| N/mm² | | | | | | | | | | |
| Porosity % | 88.2 | 81.3 | 80.1 | 86.0 | 76.2 | 91.0 | 78.9 | 79.9 | 70.1 | 76.1 |

¹⁾The viscosity of water glass composition a) was measured before addition of the surfactant.

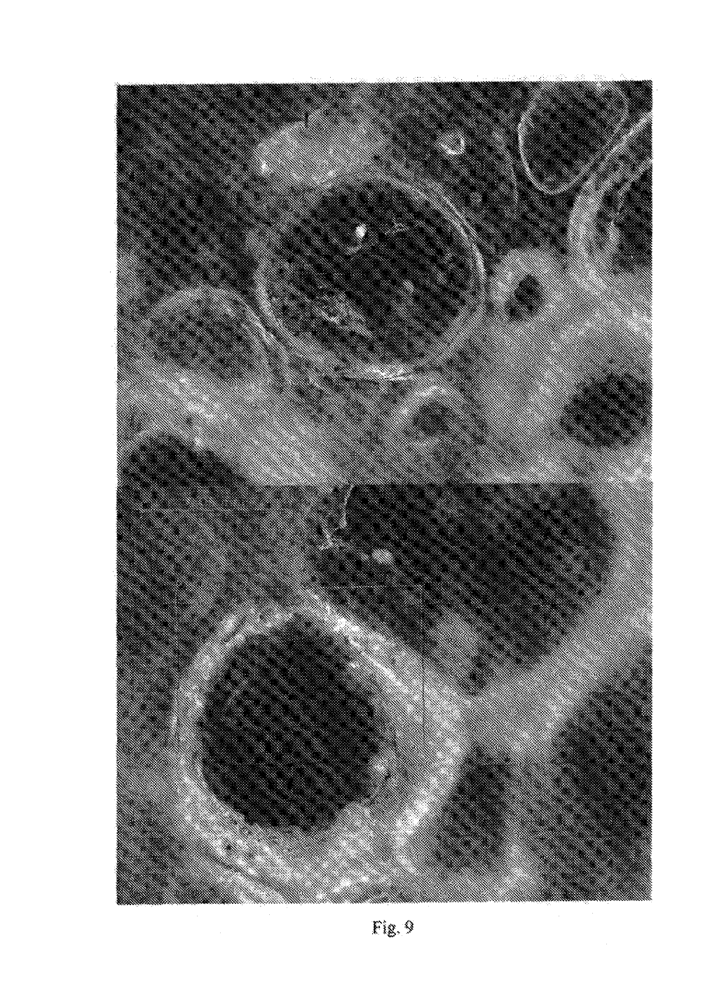

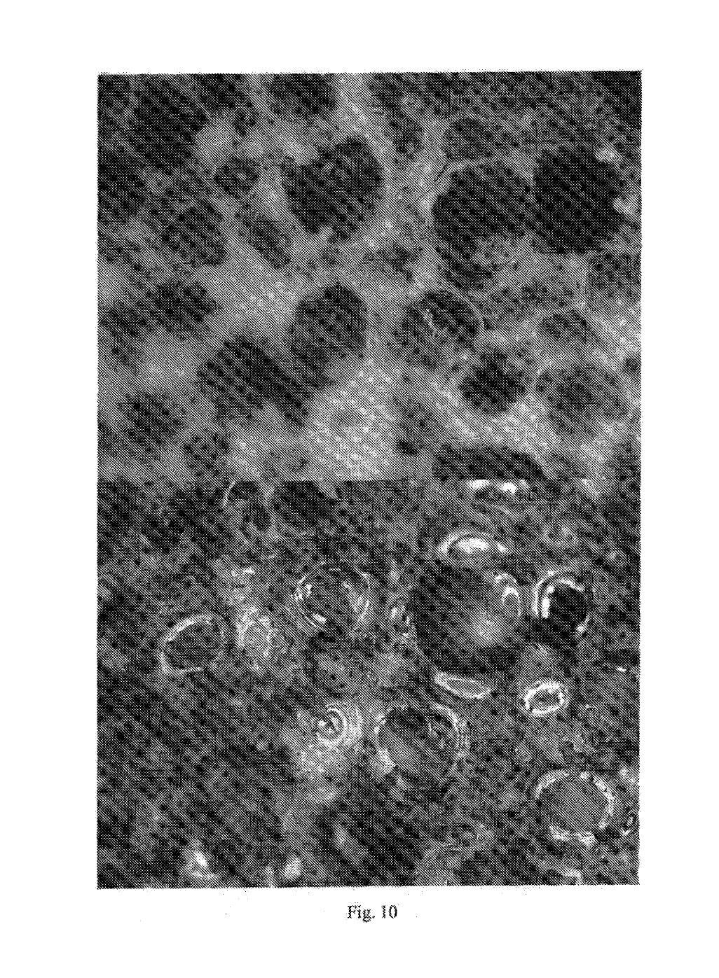

FIGS. 9 and 10 show optical microscope photographs of the product from Example 4 with 500-fold (FIG. 9) and 200-fold (FIG. 10) magnification.

### Example 11

### Suspension A

10 μl of cobalt solution dissolved in 600 μl of water, 26 g of sodium water glass 7561 (34.5% solid content), 14 g of metakaolin, 3 ml of surfactant solution A and 10 ml of triphosphate solution A.

### Solution B

500 μl of H₂O₂, 2.0 ml of propylene carbonate and 9.5 ml of water.

Suspension A and solution B were mixed and the mixture was poured into a mold. A test specimen having a density of 0.3 g/ml and a thermal conductivity of 0.05 W/mK was obtained. The porosity of the test specimen was determined as 68% and the strength as 0.1 N/mm².

The density, thermal conductivity, porosity and strength were determined here using the measurement methods described above.

### Investigations on the Mechanism

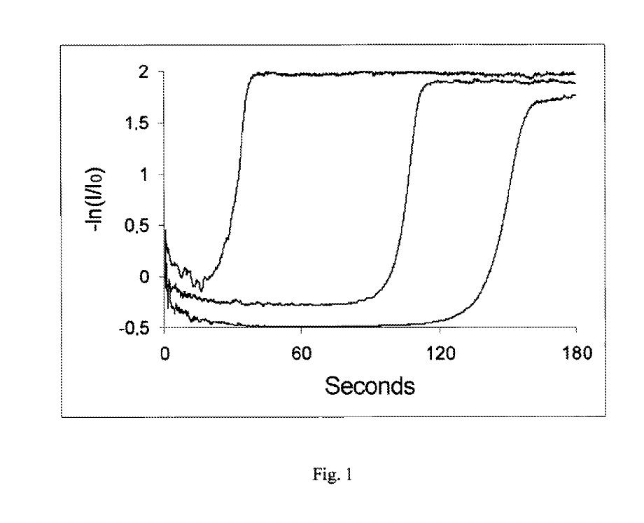

In the reaction, the light absorptions of reaction mixtures as shown in FIG. 1 were first considered.

FIG. 1 shows the light absorption based on the reference case of transmitted light in air. For this, in each case 10 ml of sodium water glass were mixed with—from left to right in FIG. 1: 15 ml, 20 ml and 25 ml—of water and in each case 2.2 ml of propylene carbonate, the mixture was shaken briefly and the transmitted light curve was then recorded. The transmitted light curve provides information on the course of the reaction. The light absorptions indicate that two fundamentally different reactions were proceeding, both of which appear to lead to polycondensation of the water glasses.

Without intending to be bound to this, the inventors assume the following course of reaction:

Native water glass does not undergo polycondensation since the negatively charged silyl anions repel each other. In the polycondensation reaction presented here an organic carbonate is mixed in rapidly and uniformly as a starter, which lowers the pH of the mixture suddenly. The organic carbonate (like CO₂ also) forms soda or potash with water glass. This “consumption” of sodium or potassium ions leads to a discharge of the negative, repelling silyl groups; the colloidal solution of the silicates in the water glass approaches its isoelectric point (the first pKa value of orthosilicic acid is pKa₁=9.84). The consequence is an accelerated condensation of the silicic acid. The operation lasts only a few minutes and leads to a plasticine-like mass which cures slowly on drying. Further curing requires no CO₂ from the air. Rather, the equilibrium is shifted towards a polycondensation of the silyl groups solely by the withdrawal of water.

It can be seen from FIG. 1 that the polycondensation has proceeded within a few minutes and can be controlled via the water content of the mixture.

Although the reaction is exothermic, the test specimen does not heat above 27° C. During the reaction the specimen solidifies but continues to remain plasticine-like. Only in the next four to six days the final hardness is reached. Experiments by the inventors have shown that this operation cannot be accelerated by an additional addition of CO₂.

### Spectroscopic Investigations

MAS-NMR spectra were recorded for further investigation. In NMR spectroscopy measurements in solids an undesirable broadening of the line generally occurs. This broadening of the line is caused by anisotropic interactions between the atomic nucleic of the sample which do not average out stochastically, quite in contrast to NMR spectroscopy measurements in solution. This broadening of the line can be reduced by measurement under the magic angle spinning (MAS) condition. For this, the sample is rotated with rotation speeds of up to 70 kHz around an axis which is tilted by 54.74° (the “magic angle”) with respect to the external magnetic field alignment. This angle leads to all dipolar interactions being averaged and therefore disappearing from the NMR spectrum. The sharp NMR signals of Al, Si and P nuclei allow an exact structure assignment in this way.

In the present invention an Advance 500 DSX 500WB from Bruker (Billerica, USA) was used at room temperature with a 4 mm ZrO₂ rotor and the rotation speed of 9 or 10 kHz; the following incident beam frequencies were used: ¹H: 500.20 MHz, ²⁹Si: 99.36176 MHz, ²⁷Al: 130.336560 MHz, ³¹P: 202.484646 MHz. A single pulse program was used with the following pulse times: 45 degree pulse for ¹H, ²⁷Al and ²⁹Si with a pulse duration of 2 μsec and for ³¹P a 30 degree pulse with a pulse duration of likewise 2 μsec. The fall times selected were: ²⁷Al: 0.5 and 0.6 sec, ²⁹Si: 6 sec, ³¹P: 25 sec.

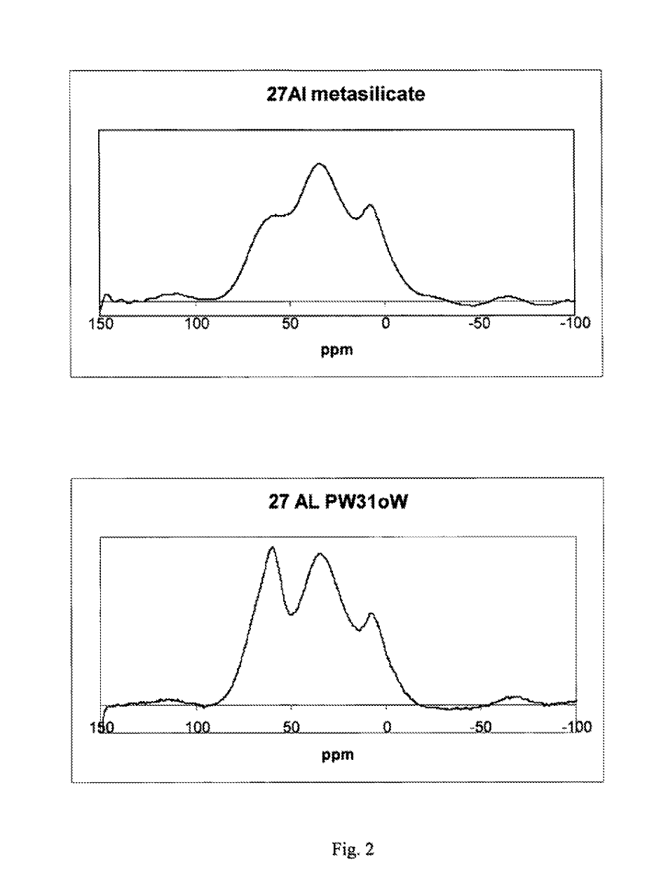

The Al MAS-NMR spectra of the metakaolin (“metasilicate”) employed and of the polymer obtained in Example 11 are shown in FIG. 2. Both spectra show maxima at 7, 35 and 62 ppm. The signal at 7 ppm can be assigned to an octahedrally coordinated Al³⁺ atom. The signal at 35 ppm belongs to a pentacoordinated Al³⁺ atom, to which a free —OH group bonds as a sixth ligand. This is the greatest signal in the metakaolin spectrum. The polymer spectrum has its greatest signal at 62 ppm. This shift is characteristic of a tetracoordinated Al³⁺ atom, which therefore carries a single negative overall charge. This is typical of a geopolymer spectrum. The Al MAS-NMR spectra are evidence of an incomplete geopolymerization. The aluminum atoms are partially incorporated in the polymer as negatively charged tetrahedra. It can also be read from the spectra, however, that some of the metakaolin has not reacted. The unreacted metakaolin contents also seem to be important for the stability of the polymer, since it is assumed that possible cracking can be stopped at these particles.

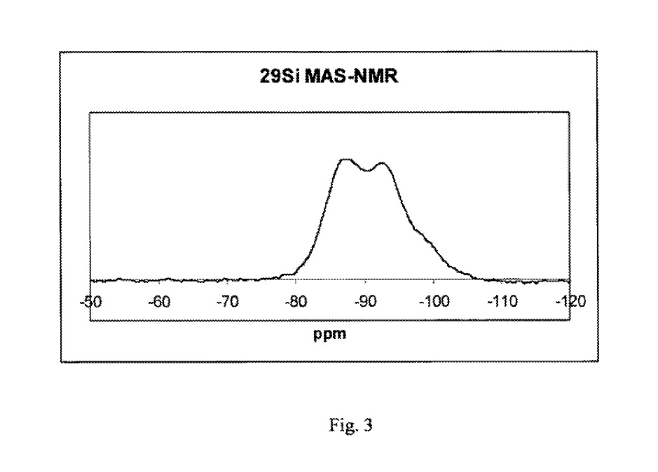

The Si MAS-NMR spectra (FIG. 3) are also very informative for being able to evaluate the bonding ratio in a polymer. A shift in the range from −70.0 to −72.0 ppm indicates monosilicates with four negative charges. The range from −77.5 to −80.7 ppm is typical of a silyl end group which carries three negative charges. The shift range from −80.0 to −82.3 ppm represents a central group in cyclotrisilicates with two negative charges, and the range from −88.0 to −90.5 ppm represents the corresponding central group of a linear chain. A branching group with a single negative charge shows a shift from −92.6 to −98.5 ppm and a broad signal up to −108 ppm is typical of a crosslinking group which no longer carries a negative charge.

The more intense the signals at shifts above −90 ppm, the more the silicon polymer is crosslinked.

In the Si MAS-NMR spectrum of the polymer, the maxima are now at shifts at −87, −92 and −99 ppm. They therefore indicate doubly negatively charged central groups, singly negatively charged branching groups and neutral branching groups. The spectrum is typical of a highly branched geopolymer.

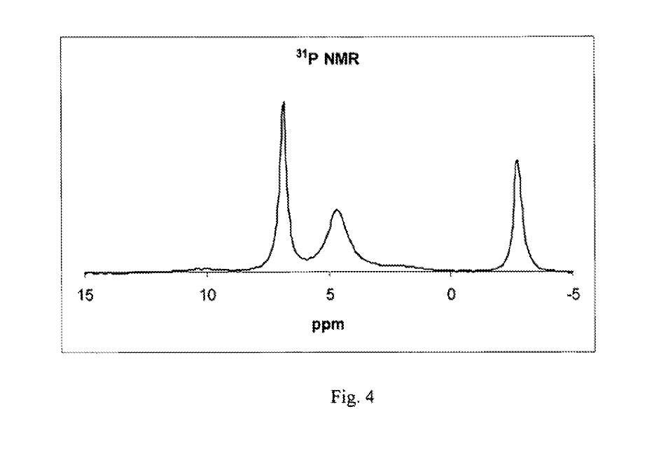

FIG. 4 shows the ³¹P NMR spectrum of the polymer of Example 11.

The pentasodium triphosphate employed shows shifts in the ³¹P NMR spectrum at 1.3, −2.4, −4.6 and −7.1 ppm.

These signals are not to be seen in the polymer (see FIG. 4). It is therefore assumed that the triphosphate has been incorporated completely into the silicon/aluminum-oxygen skeleton. Assignment of the individual signals is difficult. The signal at −2.7 ppm is the typical signal of a monophosphate group, which could have formed by hydrolysis during the reaction. The other two signals indicate phosphorus in di- and triphosphate groups which carries no negative charge, that is to say has been incorporated covalently into the Si—O skeleton.

### Investigations on Compressive Stability, Porosity and Thermal Conductivity

The methods described above were used for measurement of compressive stability, thermal conductivity and porosity.

The dependency between the amount of water glass employed and the compressive stability achieved as well as the thermal conductivity was investigated. For this, in Example 11 described above the amount of water glass employed (34.5% solution of Na water glass where s=3.3) and the amount of metakaolin were varied. As the water glass content rose, the compressive stability and thermal conductivity also rose.

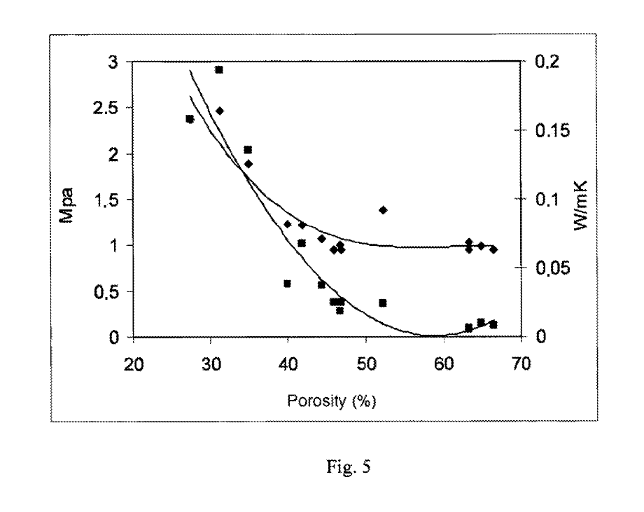

The porosity and thermal conductivity were then investigated. Porous bodies insulate better, since air is a good insulator. As FIG. 5 shows, the thermal conductivity (♦) and compressive strength (▪) in the product do not depend linearly on the porosity. These properties are important when the products according to the invention are used as insulating materials.

It can also be seen in FIG. 5 that at a porosity of more than 50% a further increase in the thermal insulating action is no longer to be observed, but the stability of the test specimens is reduced further.

### Investigations on the Viscosity of the Water Glass Composition

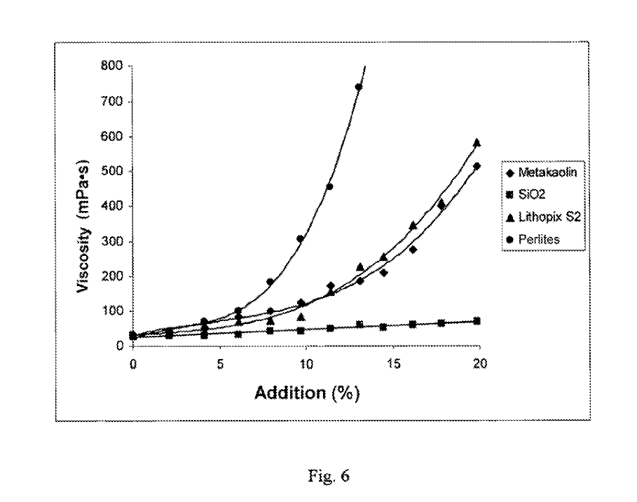

For this, using an aqueous water glass mixture comprising 15 g of Bentol 5020T and 300 g of Betolin K35 the viscosities were measured as a function of the additions metakaolin, quartz powder (SiO₂), Lithopix S2 and perlites. The result is shown in FIG. 6. As can be seen from FIG. 6, the viscosity of the water glass solution (composition a)) can be varied and adjusted to the desired value e.g. via the addition of various solid additives and the amount thereof.

### Example 12

In a subsequent experiment an amount of sodium water glass (7561) of 24 g and an amount of metakaolin of 6 g was used and 16 ml of surfactant solution A were added. A mixture of 2.4 ml of propylene carbonate in 4 ml of water and 400 μl of H₂O₂ was used as solution B. The test specimen showed a thermal conductivity of 0.035 W/mK, a density of 0.19 g/cm and a compressive strength of 0.18 N/mm².

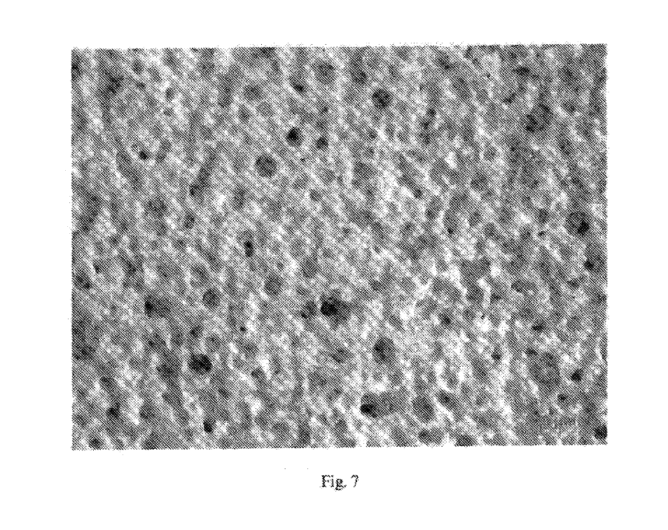

FIG. 7 shows an optical microscope photograph of the test specimen of Example 12 obtained by pouring the reaction mixture on to a glass plate, allowing it to harden and removing it from the glass plate. The photograph shows the flat surface (previously in contact with the glass plate).

### Example 13

Example 12 was repeated, but the amount of water glass was increased to 30 g, and 2 g of ZnO, 7 g of metakaolin and 15 ml of surfactant solution A were used. Curing was carried out with a mixture of 3.3 ml of propylene carbonate and 0.4 ml of H₂O₂. The test specimen had a thermal conductivity of 0.056 W/mK, a compressive strength of 1.04 N/cm² and a density of 0.32 g/cm³.

### Example 14

### Experiment with Perborate Instead of H₂O₂

Example 12 was repeated, wherein the amount of water glass was increased to 40 g. Curing was carried out with 4.4 ml of propylene carbonate, but an aqueous solution of sodium perborate (0.9 g in 10 ml of H₂O) was added instead of H₂O₂ solution. A test specimen having a density of 0.21 g/ml, a thermal conductivity of 0.048 W/mK and a compressive strength of 0.19 N/mm² was obtained.

### Example 15

### Experiment without a Glass Source

Using the same recipe as Example 12, but without hydrogen peroxide and, however, with an increased phosphate content (additionally 9 ml of phosphate solution), a test specimen having a density of 0.39 g/ml, thermal conductivity of 0.085 W/mK and compressive strength of 1.37 N/mm² was obtained. The test specimen shrank slightly during the reaction and on drying.

### Example 16

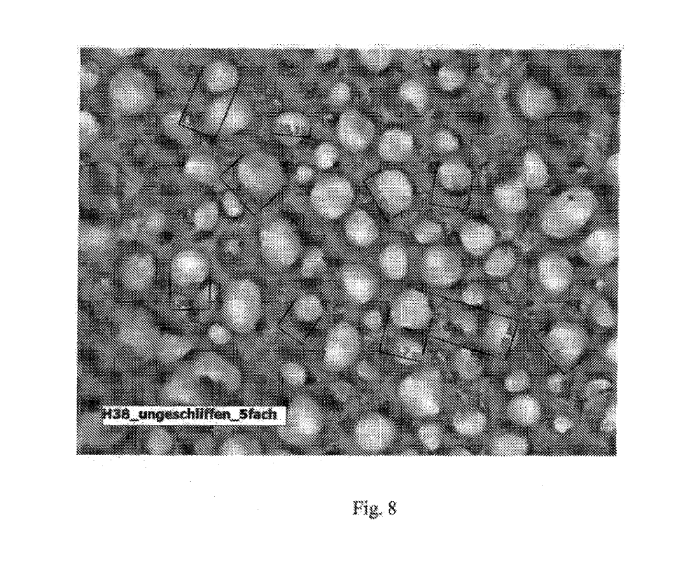

Example 12 was repeated with 24 g of sodium water glass, 16 ml of surfactant solution, 2 g of ZnO and 6 g of metakaolin in suspension A. Curing was carried out with 2.6 ml of propylene carbonate, mixed with 200 μl of H₂O₂ (35%) and 4 ml of water (solution B). The density of the test specimen was 0.28 g/ml³. The surface photograph in FIG. 8 shows that the pores obtained are closed in themselves and uniformly distributed. The body shrank on drying by less than 1 mm to a length of 6 cm. The density was 0.28 g/ml.

### Comparative Examples

Examples 1-10 were repeated, but the pH of composition a) (water glass composition) was lowered to <12 by addition of concentrated H₃PO₄. The mixture solidified in each case even before the curing agent solution could be added. On drying the product disintegrated into powder.

Examples 1-10 were repeated, but the viscosity of the water glass composition was lowered to <10 mPa·s by addition of further water. Within the usual timespan for the invention, only a formation of opaque bodies occurred; on further drying the test specimen shrank significantly and it disintegrated to a powder on drying completely.

1. A method for producing a porous mass or a porous shaped body of inorganic polymer, comprising
a) providing an aqueous composition comprising sodium and/or potassium water glass dissolved in water, wherein the composition has a pH of at least 12
b) providing a composition comprising
(i) water, wherein the amount of water is chosen such that
$$\frac{{m}_{WG}}{{G}_{a} + {G}_{b}} \times 100 \% \geq 25 \%$$
Gₐ=weight of composition provided in a) in g
G_{b}=weight of composition provided in b) in g
m_{WG}=amount of dissolved water glass in g in the composition provided in a)
and
(ii) at least one water-soluble or water-miscible curing agent,
wherein the curing agent is selected from carbonates of the general formula (I) 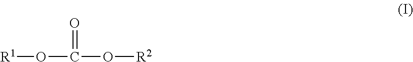
wherein R¹ and R² independently of each other are selected from C₁₋₆ alkyl optionally substituted by one or more OH groups, or R¹ and R² together with the group 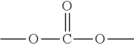
form a 5-membered ring which is optionally mono- or polysubstituted by substituents selected from C₁₋₂ alkyl and C₁₋₂ alkyl substituted by one or more OH;
and wherein the amount of carbonate m_{C} in g employed is from mₛₜₒ to x*mₛₜₒ
where
x=0.35 if dissolved Na water glass is used in a) and
x=0.45 if dissolved K water glass is used in a) and
x=0.35*y_{Na}+0.45*y_{K} if a mixture of dissolved Na water glass and dissolved K water glass is used in a), wherein
y_{Na}=weight ratio of Na water glass, based on the total amount of dissolved water glass, calculated from:
(amount in g of the dissolved Na water glass)/(total amount in g of dissolved water glass)
y_{K}=weight ratio of K water glass, based on the total amount of dissolved water glass,
wherein y_{Na}+y_{K}=1,
wherein mₛₜₒ is calculated according to the following equation (1)
mₛₜₒ=(MW_{C}/MW_{M}_{₂}_{O})*(m_{WG}(1+s)) (1)
where mₛₜₒ=stoichiometrically required amount of carbonate in g
MW_{C}=molecular weight of the carbonate used
MW_{H}_{₂}_{O}=molecular weight of M₂O from the dissolved water glass,
where M=Na or K
m_{WG}=amount of dissolved water glass in g in the composition provided in a)
s=weight ratio SiO₂/M₂O of the water glass used in a)
and wherein if a mixture of 2 or more water glasses is employed
mₛₜₒ=Σmₛₜₒ(i) (2)
and mₛₜₒ(i) is the amount of carbonate calculated for each water glass (i) according to equation (1);
and wherein if carbonate mixtures are used, for MW_{C} in equation (1)
Σ(MW_{C}(i)*m(i)) (3)
is used
where MW_{C}(i)=molecular weight of carbonate (i)
m(i)=weight ratio of carbonate (i), based on the total amount of carbonate curing agents used
wherein Σm(i)=1
and
c) bringing into contact, without supplying heat, the aqueous compositions provided in step a) and b) in order to achieve a polycondensation.

2. The method according to claim 1, wherein the composition provided in (b) additionally comprises at least one substance in dissolved form which releases O₂ by decomposition.

3. The method according to claim 2, wherein the substance releasing O₂ on decomposition is selected from H₂O₂, urea-H₂O₂ adducts, ammonium peroxydisulfate (NH₄)₂S₂O₈, percarbonates, perborates and mixtures thereof.

4. The method according to claim 2, wherein the composition provided in a) additionally comprises at least one dissolved or suspended activator for releasing O₂, the activity of which can be increased by addition of alkali metal hydroxide.

5. The method according to claim 4, wherein the activator is selected from KI, CoCl₂, KMnO₄, MnO₄, CuSO₄, FeSO₄, NiSO₄, AgNO₃ and mixtures of 2 or more of the above.

6. The method according to claim 1, wherein the composition provided in a) moreover comprises one or more solid components selected from kaolin, metakaolin, SiO₂, perlites, disperse silicic acids, dolomite, CaCO₃, Al₂O₃ and water glass powder, in homogeneously distributed form.

7. The method according to claim 6, wherein composition provided in a) comprises metakaolin and the weight ratio of dissolved water glass to metakaolin is 100:1 to 100:25.

8. The method according to claim 1, wherein the composition provided in a) moreover comprises one or more components selected glass fibers, rock wool, basalt fibers, cellulose fibers, pumice, glass beads and Styropor beads, in homogeneously distributed form.

9. The method according to claim 1, wherein the composition provided in a) moreover comprises one or more oxides of polyvalent metals.

10. The method according to claim 9, wherein the oxides are one or more selected from ZnO, TiO₂, MnO, PbO, PbO₂, Fe₂O₃, FeO, Fe₃O₄, ZrO₂, Cr₂O₃, CuO, BaO, SrO, BeO and MgO.

11. The method according to claim 1, wherein the composition provided in a) moreover comprises one or more sulfates selected from alkali metal sulfates and alkaline earth metal sulfates.

12. The method according to claim 1, wherein the composition provided in a) moreover comprises one or more surface-active substances.

13. The method according to claim 12, wherein one or more nonionic surfactants are used.

14. The method according to claim 1, wherein the composition provided in a) moreover comprises one or more phosphates selected from mono-, di-, tri- and polyphosphates.

15. The method according to claim 14, wherein the phosphate is selected from di-, tri- or polyphosphates of sodium or aluminum and mixtures of 2 or more thereof.

16. The method according to claim 1, wherein the composition provided in a) moreover comprises one or more alkyl siliconates.

17. The method according to claim 1, wherein the curing agent is at least one from ethylene carbonate, propylene carbonate, butylene carbonate, dimethyl carbonate and glycerol carbonate.

18. The method according to claim 1, wherein the dissolved water glass in the composition provided in a) is potassium water glass or a 50:50 mixture of sodium water glass and potassium water glass.

19. The method according to claim 1, wherein the dissolved water glass in the composition provided in a) is a mixture of water glasses and the ratio of water glass having an s value of from 1.3 to 5 is at least 90%, based on the total amount of dissolved water glass.

20. A porous mass or shaped body obtainable by the method according to claim 1.

21. A porous mass or shaped body of polycondensed sodium and/or potassium water glass, characterized in that the pores are homogeneously distributed and the porosity is 40 to 95%.

22. The porous mass or shaped body according to claim 21, wherein the porosity is 65 to 85%.

23. The porous mass or shaped body according to claim 20, wherein the density is 0.05 to 0.5 g/cm³.

24. The use of the porous mass or the porous shaped body according to claim 20 as insulating material, foam brick, for foundry auxiliary bodies, injection material for hollow cavities, catalyst support, material for thin layer or column chromatography or for rapid prototyping.

25. A foundry auxiliary body which comprises a porous mass according to claim 20 in at least one region flowed into during the casting operation.

26. A composite material, characterized in that a part thereof is made of a porous mass according to claim 20.
